(19) United States
(12) Patent Application Publication
(10) Pub. No.: US 2024/0117943 A1
(43) Pub. Date: Apr. 11, 2024

(54) IDENTIFICATION OF CLUSTERS AND SOURCES OF METHANE

(71) Applicant: Aclima Inc., San Francisco, CA (US)

(72) Inventors: Shreyan Sen, Raleigh, NC (US); Zachary Kent Smith, New Lebanon, OH (US); Todd Langland, El Granada, CA (US); Marek Andrzej Kwasnica, Astoria, NY (US); Rishabh Urvesh Shah, Everett, WA (US); Meghan Elizabeth Thurlow, San Francisco, CA (US); Brian LaFranchi, Berkeley, CA (US); Nathan Sankary, Los Altos Hills, CA (US); Matthew Hill, San Francisco, CA (US); Tobe Corazzini, Auburn, CA (US); Davida Herzl, San Francisco, CA (US)

(21) Appl. No.: 18/378,871

(22) Filed: Oct. 11, 2023

Related U.S. Application Data
(60) Provisional application No. 63/415,223, filed on Oct. 11, 2022.
(60) Provisional application No. 63/442,910, filed on Feb. 2, 2023.
(60) Provisional application No. 63/532,021, filed on Aug. 10, 2023.

(51) Int. Cl. F17D 5/00; F17D 5/02

(52) U.S. Cl. CPC F17D 5/005; F17D 5/02

(57) ABSTRACT

A system, device, and method for detecting leaks near an emitter is disclosed. The method includes (i) receiving, from one or more mobile sensors, a first stream of information indicative of a leak state, (ii) determining that an initial leak state exists based at least in part on the first stream of information indicative of the leak state, (iii) receiving a second stream of information indicative of a no-leak state, (iv) using a statistical model to determine that the leak state has ended based at least in part on the first stream of information and the second stream of information, (v) receiving a third stream of information indicative of the leak state, and (vi) determining that a new leak state exists, wherein the new leak state is a distinct leak state from the initial leak state.

### CROSS REFERENCE TO OTHER APPLICATIONS

This application claims priority to U.S. Provisional Patent Application No. 63/415,223 entitled LEAK LIFECYCLE ANALYSIS filed Oct. 11, 2022 which is incorporated herein by reference for all purposes; claims priority to U.S. Provisional Patent Application No. 63/442,910 entitled METHANE SOURCE INDICATOR filed Feb. 2, 2023 which is incorporated herein by reference for all purposes; and claims priority to U.S. Provisional Patent Application No. 63/532,021 entitled METHANE SOURCE INDICATOR filed Aug. 10, 2023 which is incorporated herein by reference for all purposes.

### BACKGROUND OF THE INVENTION

Monitoring of environmental conditions includes measuring the levels of various components of the surroundings, allowing detection of potentially harmful air pollution, radiation, greenhouse gases, or other contaminants in the environment. Depending on the application, environmental monitoring systems can be used in outdoor or indoor settings. Monitoring of environmental conditions typically includes gathering environmental data. Environmental data includes detection and measurement of pollutants or contaminants such as nitrogen dioxide (NO₂), carbon monoxide (CO), nitrogen oxide (NO), ozone (O₃), sulfur dioxide (SO₂), carbon dioxide (CO₂), methane (CH₄), volatile organic compounds (VOC), air toxics, temperature, sound radiation, and particulate matter. In order to assess the effects of such pollutants, it is desirable to associate environmental data sensing these pollutants at particular times with geographic locations (homes, businesses, towns, etc.). Such an association would allow individuals and communities to evaluate the quality of their surroundings. Thus, data collected that is representative of the region is desired to be collected. Further, the data collected is desired to meet desired error tolerances, and be collected and processed efficiently. Thus, a mechanism for improving collection and processing of environmental data is desired.

### BRIEF DESCRIPTION OF THE DRAWINGS

Various embodiments of the invention are disclosed in the following detailed description and the accompanying drawings.

FIG. 1 illustrates an embodiment of a system for capturing environmental data using mobile sensor platforms and associating the environmental data with map features.

FIG. 2 illustrates an embodiment of a method for capturing environmental data using mobile sensor platforms.

FIGS. 3A-3C illustrate a particular region and the embodiment of routes that may be traversed using a method for capturing environmental data using mobile sensor platforms.

FIG. 4 illustrates a relationship between methane and ethane signals in collected sensor data according to various embodiments.

FIG. 5A illustrates an example of a calibration of a set of sensors according to various embodiments.

FIGS. 5B and 5C illustrate examples of a rolling baseline signals according to a first time window relative to methane and ethane signals according to various embodiments.

FIGS. 5D and 5E illustrate examples of a rolling baseline signals according to a second time window relative to methane and ethane signals according to various embodiments.

FIG. 5F illustrates an example of an ethane signal relative to various baselines according to various embodiments.

FIGS. 6A and 6B illustrate an example of a map comprising methane signals from different source types according to various embodiments.

FIG. 7 illustrates a method for calibrating a sensor according to various embodiments.

FIG. 8 illustrates a method for determining obtaining different pollutant signals in sensor data collected from a sensor(s) according to various embodiments.

FIG. 9 illustrates a method for classifying a source type for a pollutant based on sensor data according to various embodiments.

FIG. 10 illustrates a method for determining a source type for a first gas detected based on sensor data according to various embodiments.

FIG. 11 illustrates a method for providing a model to predict a leak probability at various locations within a predefined geographic area according to various embodiments.

FIG. 12 illustrates a relationship between a detection probability distribution and a leak probability distribution according to various embodiments.

FIG. 13 illustrates a method for determining a leak state for a cluster according to various embodiments.

FIG. 14 illustrates a method for determining a leak state for a particular leak according to various embodiments.

FIG. 15 illustrates a method for determining a leak state for a particular leak according to various embodiments.

FIG. 16 illustrates a method for associating detected peaks in the sensor data with a new or existing cluster associated with a particular leak according to various embodiments.

FIG. 17 illustrates a method for detecting leaks according to various embodiments.

FIG. 18 illustrates a method for providing leak data according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Related art systems provided an indication that a detection of a leak, such as by generating a map for a region in which the map comprised an indicator of the occurrence of a leak. However, related art systems did not intelligently shut off leaks (e.g., make an intelligent determination to transition a leak from an active state to an inactive state). Rather, such systems either never shut off leaks (e.g., the leaks would be shown as persisting long past the time the leak was actually repaired), or arbitrarily shut off leaks according to a predefined time threshold after which a detected leak is deemed to have been shut off. These related art systems did not provide an accurate measure or characterization of pollutant detections. For example, related art systems did not classify the types of leaks (e.g., identify the source type as thermogenic or biogenic) based on the sensor data, and did not use robust techniques for determining when a leak started and when a leak ended. This low-resolution data does not allow organizations (e.g., regulatory agencies, municipalities, utilities) to accurately determine the extent of the pollution caused by leaks.

Various embodiments provide a system, method, and device for probabilistically characterizing leaks. The system deploys a model (e.g., a Hidden Markov Model) to predict whether a leak is active or inactive (e.g., in a leak-on or no-leak state). The model uses robust statistical analysis to provide an accurate prediction of when a leak is detected, where the leak is occurring (e.g., clustering positive pollutant detections into different leaks), and when the leak transitions to an inactive state. The accurate determination of the lifespan of a leak (e.g., the leak start date and the leak end date) allows for a more accurate determination of the gross pollution associated with the leak, which may be used in connection with levying fines, deploying repair resources, etc.

In some embodiments, the system clusters positive pollutant detections as a leak. The system re-runs the model for each date in the cluster's history to determine when the model predicts that model stopped. The parameters for the model are tuned to balance the competing goals of having a high confidence that a leak has been shut off (e.g., transitioned to an inactive state) and not delaying the transition of an active leak to an inactive leak because the model was waiting for sufficient confidence that the leak was shut off (e.g., the model waited for too many observations of no-leak before determining that the leak was inactive). Based on the tuning of the model parameters, the model could be set to take a long time to declare with a high confidence that a leak stopped, or on the other end of the spectrum the model may be tuned to be too aggressive, which could lead to the model falsely conclude that leak has stopped based on one or a few detections of no peak.

In some embodiments, the system determines whether a detection is thermogenic or biogenic. In the case of methane detections, the system accurately classifies the detections as thermogenic or biogenic based at least in part on the detection of the co-occurrence of ethane. Thermogenic sources of methane exhibit a co-occurrence of ethane, while biogenic sources of methane do not have a corresponding occurrence of ethane. The use of ethane in connection with classifying the leak is complicated by the low intensity of ethane emitted relative to the intensity of methane emission during a leak. Because the intensity of ethane detections is so low, systems may confuse ethane detections with sensor noise. The system uses statistical analysis in connection with calibrating sensors and detecting the occurrence of ethane in the face of some fundamental sensor noise baseline. By classifying methane leaks as thermogenic and biogenic, the system can provide an accurate indication to organizations (e.g., municipalities, utilities, regulatory agencies) of the methane source type (e.g., the system identifies leaks arising from gas pipelines, etc.).

Various embodiments provide a system, device, and method for classifying a gas signal. The method includes (i) receiving, from one or more mobile sensors, sensor data collected over a geographic region, (ii) detecting a first gas signal in the sensor data, (iii) determining a source type for the first gas based at least in part on a determination of whether the sensor data comprises a signal for another pollutant, and (iv) providing the source type. The first gas signal may correspond to a methane gas signal. As an example, the other pollutant may correspond to ethane. In some embodiments, the source type is deemed to correspond to a biogenic source type in response to a determination that the sensor data comprises the methane gas signal without a presence of an ethane gas signal. In some embodiments, the source type is deemed to correspond to a thermogenic source type in response to a determination that the sensor data comprises the methane gas signal and an ethane gas signal. As an example, the system may deem the sensor data to comprise an ethane signal in response to a determination that ethane measurements in the sensor data exceeds a noise baseline by a predefined extent. The predefined extent corresponds to at least 300% of the noise baseline (e.g., the ethane signal is three times the noise baseline). As an example, the noise baseline is a rolling baseline over a predefined time window.

Various embodiments provide a system, device, and method for ranking of sub regions within a geographic region based on an extent of a gas leak. The method includes (i) obtaining sensor data collected over a geographic region, wherein the sensor data is collected by one or more mobile sensors, (ii) determining a model to predict a leak probability for one or more subregions within the geographic region based at least in part on the sensor data, a detection probability, and a collection intensity, and (iii) providing the model. In some embodiments, the model is used in connection with determining a time at which a leak started and a time at which a leak ended. As an example, the one or more subregions comprises one or more road segments within the geographic region. In some embodiments, the detection probability includes a leak component corresponding to a probability of detecting a leak, and a no-leak component corresponding to a probability of detecting no leak. The detection probability may further include a probability of detecting the leak if the leak is present.

Various embodiments provide a system, device, and method for detecting leaks near an emitter is disclosed. The method includes (i) receiving, from one or more mobile sensors, a first stream of information indicative of a leak state, (ii) determining that an initial leak state exists based at least in part on the first stream of information indicative of the leak state, (iii) receiving a second stream of information indicative of a no-leak state, (iv) using a statistical model to determine that the leak state has ended based at least in part on the first stream of information and the second stream of information, (v) receiving a third stream of information indicative of the leak state, and (vi) determining that a new leak state exists, wherein the new leak state is a distinct leak state from the initial leak state.

Hyper-local environmental data, for example related to air quality and greenhouse gas data, can be collected using vehicles with air pollutant sensors installed. Embodiments of techniques usable in gathering hyper-local data are described in U.S. patent application Ser. No. 16/682,871, filed on Nov. 13, 2019, entitled HYPER-LOCAL MAPPING OF ENVIRONMENTAL CONDITIONS and assigned to the assignee of the present application, U.S. patent application Ser. No. 16/409,624, filed on May 10, 2019, entitled INTEGRATION AND ACTIVE FLOW CONTROL FOR ENVIRONMENTAL SENSORS and assigned to the assignee of the present application; U.S. patent application Ser. No. 16/773,873, filed on Jan. 27, 2020, entitled SENSOR DATA AND PLATFORMS FOR VEHICLE ENVIRONMENTAL QUALITY MANAGEMENT, assigned to the assignee of the present application and which claims priority to U.S. Patent Application Ser. No. 62/798,395 entitled SENSOR DATA AND PLATFORMS FOR VEHICLE ENVIRONMENTAL QUALITY MANAGEMENT and assigned to the assignee of the present application, which are all incorporated herein in their entirety for all purposes.

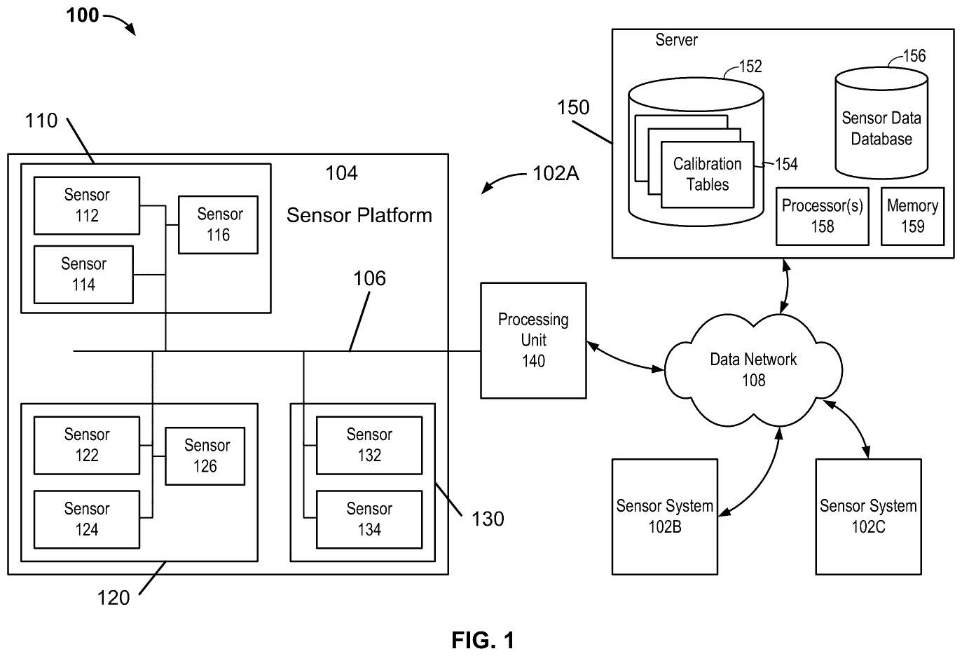

FIG. 1 depicts an embodiment of a system 100 for collecting and processing environmental data. System 100 includes multiple mobile sensor platforms 102A, 102B, 102C and server 150. In some embodiments, system 100 may also include one or more stationary sensor platforms 103, of which one is shown. Stationary sensor platform 103 may be used to collect environmental data at a fixed location. The environmental data collected by stationary sensor platform 103 may supplement the data collected by mobile sensor platforms 102A, 102B and 102C. Thus, stationary sensor platform 103 may have sensors that are the same as or analogous to the sensors for mobile sensor platforms 102A, 102B and 102C. In other embodiments, stationary sensor platform 103 may be omitted. Although a single server 150 is shown, multiple servers may be used. The multiple servers may be in different locations. Although three mobile sensor platforms 102A, 102B and 102C are shown, other numbers of sensors/mobile sensor platforms are typically present. Mobile sensor platforms 102A, 102B and 102C and stationary sensor platform(s) 103 may communicate with server 150 via a data network 108. The communication may take place wirelessly.

Mobile sensor platforms 102A, 102B and 102C may be mounted in a vehicle, such as an automobile or a drone. In some embodiments, mobile sensor platforms 102A, 102B and 102C are desired to stay in proximity to the ground to be better able to sense conditions analogous to what a human would experience. Mobile sensor platform 102A includes a bus 106, sensors 110, 120 and 130. Although three sensors are shown, another number may be present on mobile sensor platform 102A. In addition, a different configuration of components may be used with sensors 110, 120 and 130. Each sensor 110, 120 and 130 is used to sense environmental quality and may be of primary interest to a user of system 100. For example, sensors 110, 120 and 130 may be gas sensors, volatile organic compound (VOC) sensors, particulate matter sensors, radiation sensors, noise sensors, light sensors, temperature sensors, noise sensors or other analogous sensors that capture variations in the environment. For example, sensors 110, 120 and 130 may be used to sense one or more of NO₂, CO, NO, O₃, SO₂, CO₂, VOCs, CH₄, particulate matter, noise, light, temperature, radiation, and other compounds. In some embodiments, sensor 110, 120 and/or 130 may be a multi-modality sensor. A multi-modality gas sensor senses multiple gases or compounds. For example, if sensor 110 is a multi-modality NO₂/O₃ sensor, sensor 110 might sense both NO₂ and O₃ together. Sensor 110 may comprise a plurality of sensors, such as sensors 112, 114, and 116. Sensor 120 may comprise a plurality of sensors, such as sensors 122, 124, and 126. Sensor 130 may comprise a plurality of sensors, such as sensors 132 and 134.

Although not shown in FIG. 1, other sensors co-located with sensors 110, 120 and 130 may be used to sense characteristics of the surrounding environment including, in some instances, other gases and/or matter. Such additional sensors are exposed to the same environment as sensors 110, 120 and 130. In some embodiments, such additional sensors are in close proximity to sensors 110, 120 and 130, for example within ten millimeters or less. In some embodiments, the additional sensors may be further from sensors 110, 120 and 130 if the additional sensors sample the same packet of air inside of a closed system, such as a system of closed tubes. In some embodiments, temperature and/or pressure are sensed by these additional sensors. For example, an additional sensor co-located with sensor 110 may be a temperature, pressure, and relative humidity (T/P/RH) sensor. These additional co-located sensors may be used to calibrate sensors 110, 120 and/or 130. Although not shown, sensor platform 102A may also include a manifold for drawing in air and transporting air to sensors 110, 120 and 130 for testing.

Sensors 110, 120 and 130 provide sensor data over bus 106, or via another mechanism. In some embodiments, data from sensors 110, 120 and 130 incorporates time. This time may be provided by a master clock (not shown) and may take the form of a timestamp. Master clock may reside on sensor platform 102A, may be part of processing unit 140, or may be provided from server 150. As a result, sensors 110, 120 and 130 may provide timestamped sensor data to server 150. In other embodiments, the time associated with the sensor data may be provided in another manner. Because sensors 110, 120 and 130 generally capture data at a particular frequency, sensor data is discussed as being associated with a particular time interval (e.g., the period associated with the frequency), though the sensor data may be timestamped with a particular value. For example, sensors 110, 120 and/or 130 may capture sensor data every second, every two seconds, every ten seconds, or every thirty seconds. The time interval may be one second, two seconds, ten seconds, or thirty seconds. The time interval may be the same for all sensors 110, 120 and 130 or may differ for different sensors 110, 120 and 130. In some embodiments, the time interval for a sensor data point is centered on the timestamp. For example, if the time interval is one second and a timestamp is t1, then the time interval may be from t1−0.5 seconds to t1+0.5 seconds. However, other mechanisms for defining the time interval may be used.

Sensor platform 102A also includes a position unit 145 that provides position data. In some embodiments, position unit 145 is a global positioning satellite (GPS) unit. Consequently, system 100 is described in the context of a position unit 145. The position data may be time-stamped in a manner analogous to sensor data. Because position data is to be associated with sensor data, the position data may also be considered associated with time intervals, as described above. However, in some embodiments, position data (e.g., GPS data) may be captured more or less frequently than sensor data. For example, position unit 145 may capture position data every second, while sensor 130 may capture data every thirty seconds. Thus, multiple data points for the position data may be associated with a single thirty second time interval. The position data may be processed as described below.

Optional processing unit 140 may perform some processing and functions for data from sensor platform 104, may simply pass data from sensor platform 104 to server 150 or may be omitted.

Mobile sensors platforms 102B and 102C are analogous to mobile sensor platform 102A. In some embodiments, mobile sensor platforms 102B and 102C have the same components as mobile sensor platform 102A. However, in other embodiments, the components may differ. However, mobile sensor platforms 102A, 102B and 102C function in an analogous manner.

Server 150 includes sensor data database 156, calibration tables 154 (e.g., stored in database 152), processor(s) 158, memory 159. Processor(s) 158 may include multiple cores. Processor(s) 158 may include one or more central processing units (CPUs), one or more graphical processing units (GPUs) and/or one or more other processing units. Memory 159 can include a first primary storage, typically a random-access memory (RAM), and a second primary storage area, typically a non-volatile storage such as solid-state drive (SSD) or hard disk drive (HDD). Memory 159 stores programming instructions and data for processes operating on processor(s) 158. Primary storage typically includes basic operating instructions, program code, data and objects used by processor(s) 158 to perform their functions. Primary storage devices (e.g., memory 159) may include any suitable computer-readable storage media, described below, depending on whether, for example, data access needs to be bi-directional or uni-directional.

Sensor data database 156 includes data received from mobile sensor platforms 102A, 102B and/or 102C. After capture by mobile sensor platform 102A, 102B and/or 102C, sensor data stored in sensor data database 156 may be operated on by various analytics, as described below. Position data database 152 stores position data received from mobile sensor platforms 102A, 102B and/or 102C. In some embodiments, sensor data database 156 stores position data as well as sensor data. In such embodiments, position data database 152 may be omitted. Server 150 may include other databases and/or store and utilize other data. For example, server 150 may include calibration data (not shown) used in calibrating sensors 110, 120 and 130.

System 100 may be used to capture, analyze, and provide information regarding hyper-local environmental data. Mobile sensor platforms 102A, 102B and 102C may be used to traverse routes and provide sensor and position data to server 150. Server 150 may process the sensor data and position data. Server 150 may also assign the sensor data to map features corresponding to the locations of mobile sensor platforms 102A, 102B and 102C within the same time interval as the sensor data was captured. As discussed above, these map features may be hyper-local (e.g., one hundred meter or less road segments or thirty meter or less road segments). Thus, mobile sensor platforms 102A, 102B and 102C may provide sensor data that can capture variations on this hyper-local distance scale. Server 150 may provide the environmental data, a score, confidence score and/or other assessment of the environmental data to a user. Thus, using system 100 hyper-local environmental data may be obtained using a relatively sparse network of mobile sensor platforms 102A, 102B and 102C, associated with hyper-local map features and processed for improved understanding of users.

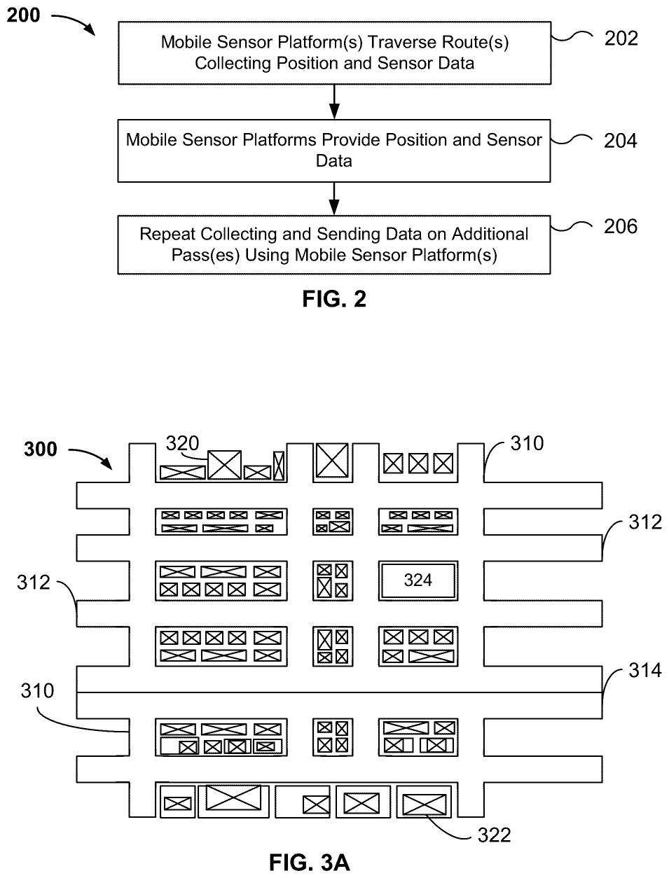

FIG. 2 depicts an exemplary embodiment of method 200 for capturing environmental data using mobile sensor platforms, such as mobile sensor platforms 102A, 102B and/or 102C. Method 200 is described in the context of system 100, but may be performed using other systems. For clarity, only some portions of method 200 are shown. Although shown in a sequence, in some embodiments, processes may occur in parallel and/or in a different order.

Mobile sensor platforms traverse routes in a geographic region, at 202. While traversing the routes, the mobile sensor platforms collect not only sensor data, but also position data. For example, a mobile sensor platform may sense one or more of NO₂, CO, NO, O₃, SO₂, CO₂, CH₄, VOCs, particulate matter, other compounds, radiation, noise, light, and other environmental data at various times during traversal of the route. Other environmental characteristics, including but not limited to temperature, pressure, and/or humidity may also be sensed at 202. In addition, the time corresponding to the environmental data is also captured. The time may be in the form of a timestamp for the sensor data (sensor timestamp), which may correspond to a particular time interval. Different sensors on the mobile sensor platform may capture the environmental data at different times and/or at different frequencies. Also, at 202 the mobile sensor platforms capture position data, for example via a GPS unit. The position data may include location (as indicated by a GPS unit), velocity and/or other information related to the geographic location of the mobile sensor platform. In some embodiments, position data from other sources, such as acceleration, may be captured from by the vehicle or another source. The position data may include a timestamp (position timestamp) or other indicator of the time at which the position data is captured.

The mobile sensor platforms provide the position and sensor data to a server, at 204. In some embodiments, mobile sensor platforms provide this data substantially in real time, as the mobile sensor platforms traverse their routes at 202. Thus, the position and sensor data may be transmitted wirelessly to the server. In some embodiments, some or all of the position and/or sensor data is stored at the mobile sensor platform and provided to the server at a later time. For example, the data may be transferred to the server when the mobile sensor platform returns to its base. In some embodiments, the mobile sensor platform may process the sensor data and/or position data prior to sending the sensor and/or position data to the server. In other embodiments, the mobile sensor platform provides little or no processing. The sensor data and position data may be sent at the same time or may be sent separately.

At 206, the route traversal and data collecting of 202 and data sending of 204 are repeated. Thus, the mobile sensor platforms may traverse the same or different routes at 206. In either case, multiple passes of the same geographic locations, and thus multiple passes of the same corresponding map features, are made at 206. In some embodiments, the repetition at 206 may be periodic (e.g., approximately every week, month, or other time period). In some embodiments, the repetition at 206 may be performed based on other timing. In some cases, the same mobile sensor platform is sent on the same route and/or collects data for the same map features. In some embodiments, different mobile sensor platforms collect data may be used for the same routes and/or map features. Also at 206, steps 202 and 204 may be performed multiple times. Thus, at 206, data for a particular region may be aggregated over time.

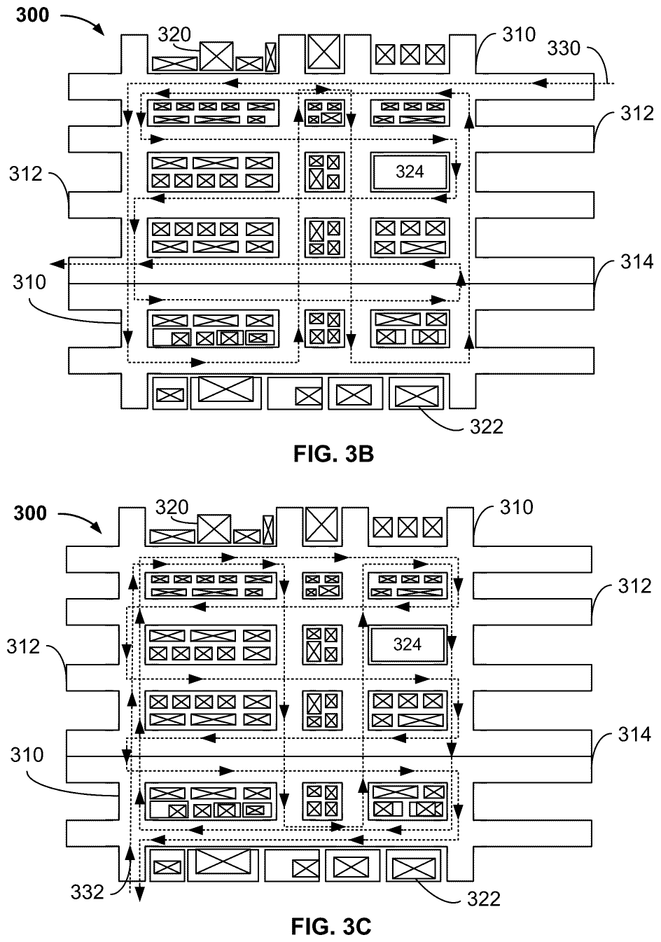

For example, FIGS. 3A-3C illustrate a particular geographic region and the routes that may be traversed using method 200. A map 300 corresponding to the geographic region is shown in FIG. 3A. Map 300 may be an open-source map or generated by another mapping tool. Map 300 includes streets 310 (oriented vertically on the page) and 312 (oriented horizontally on the page); larger street/highway 314, structures 320 and 322 and open area 324. For simplicity, only one of each structure 320 and 322 is labeled. Open area 324 may correspond to a park, vacant lot, or analogous item. As can be seen in FIG. 3A, the density and size of structures 320 and 322 vary across map 300. Similarly, the density and size of streets 312, 314 and 320 also varies. In addition, structures 322 are more clearly separated by open regions, which may correspond to a yard or analogous area.

FIG. 3B illustrates map 300 as well as route 330 that may be traversed by a mobile sensor platform, such as mobile sensor platform 102A. At 202, mobile sensor platform 102A may traverse route 330. As can be seen in FIG. 3B, the route 330 includes a portion of each street 312 and 314 in map 300. Some portions of some streets are traversed multiple times for the same route 330. In some embodiments, this is still considered a single pass of these streets. As mobile sensor platform 102A traverses route 330 at 202, sensor data is captured by sensors 110, 120 and 130. Also at 202, position data is captured by position unit 145 throughout route 330. In some embodiments, the vehicle carrying mobile sensor platform 102A travels sufficiently slowly while traversing route 330 that sensor data and position data can be accurately captured for particular position(s). In some embodiments, mobile sensor platform 102A travels at a velocity that allows for multiple sensor data points for each map feature. Mobile sensor platform 102A also sends position and sensor data to server 150 at 204. This may be done while mobile sensor platform 102A traverses route 330 or at a later time. Other mobile sensor platforms 102B and/or 102C may also traverse the same or different routes and send data to server 150 at 202 and 204. Thus, multiple mobile sensor platforms may be used in method 200.

At 206, mobile sensor platform 102A and/or other mobile sensor platform(s) 102B and 102C repeat the route traversal, data collection and sending of the position and sensor data. In some cases, mobile sensor platform(s) 102A, 102B and/or 102C follow route 330 again. In some cases, mobile sensor platform(s) 102A, 102B and/or 102C traverses a different route. For example, FIG. 3C depicts map 300 with another route 332. As part of 206, mobile sensor platform(s) 102A, 102B and/or 102C may traverse route 332, collecting position and sensor data at 206 (repeating 202). In some embodiments, the vehicle carrying mobile sensor platform(s) 102A, 102B and/or 102C travels sufficiently slowly while traversing route 332 that sensor data and position data can be accurately captured for particular position(s). In some embodiments, mobile sensor platform(s) 102A, 102B and/or 102C travels at a velocity that allows for multiple sensor data points for each map feature (described below). Mobile sensor platform(s) 102A, 102B and/or 102C send sensor and position data to server 150 at 206 (repeating 204) during or after traversing route 330 and/or route 332.

Thus, using method 200, sensor and position data may be captured for regions of a map. The sensor data and position data may be provided to server 150 or other component for processing, aggregation, and analysis. Sensor data and position data are sensed sufficiently frequently using method 200 that variations environmental quality on the hyper-local scales may be reflected in the sensor data. Method 200 may be performed using a relatively small number of mobile sensor platforms. Consequently, efficiency of data gathering may be improved while maintaining sufficient sensitivity in both sensor and position data.

For example, FIGS. 3A-3C illustrate a particular geographic region and the routes that may be traversed using method 200. A map 300 corresponding to the geographic region is shown in FIG. 3A. Map 300 may be an open-source map or generated by another mapping tool. Map 300 includes streets 310 (oriented vertically on the page) and 312 (oriented horizontally on the page); larger street/highway 314, structures 320 and 322 and open area 324. For simplicity, only one of each structure 320 and 322 is labeled. Open area 324 may correspond to a park, vacant lot, or analogous item. As can be seen in FIG. 3A, the density and size of structures 320 and 322 vary across map 300. Similarly, the density and size of streets 312, 314 and 320 also varies. In addition, structures 322 are more clearly separated by open regions, which may correspond to a yard or analogous area.

FIG. 3B illustrates map 300 as well as route 330 that may be traversed by a mobile sensor platform, such as mobile sensor platform 102A. At 202, mobile sensor platform 102A may traverse route 330. As can be seen in FIG. 3B, the route 330 includes a portion of each street 312 and 314 in map 300. Some portions of some streets are traversed multiple times for the same route 330. In some embodiments, this is still considered a single pass of these streets. As mobile sensor platform 102A traverses route 330 at 202, sensor data is captured by sensors 110, 120 and 130. Also at 202, position data is captured by position unit 145 throughout route 330. In some embodiments, the vehicle carrying mobile sensor platform 102A travels sufficiently slowly while traversing route 330 that sensor data and position data can be accurately captured for particular position(s). In some embodiments, mobile sensor platform 102A travels at a velocity that allows for multiple sensor data points for each map feature. Mobile sensor platform 102A also sends position and sensor data to server 150 at 204. This may be done while mobile sensor platform 102A traverses route 330 or at a later time. Other mobile sensor platforms 102B and/or 102C may also traverse the same or different routes and send data to server 150 at 202 and 204. Thus, multiple mobile sensor platforms may be used in method 200.

At 206, mobile sensor platform 102A and/or other mobile sensor platform(s) 102B and 102C repeat the route traversal, data collection and sending of the position and sensor data. In some cases, mobile sensor platform(s) 102A, 102B and/or 102C follow route 330 again. In some cases, mobile sensor platform(s) 102A, 102B and/or 102C traverses a different route. For example, FIG. 3C depicts map 300 with another route 332. As part of 206, mobile sensor platform(s) 102A, 102B and/or 102C may traverse route 332, collecting position and sensor data at 206 (repeating 202). In some embodiments, the vehicle carrying mobile sensor platform(s) 102A, 102B and/or 102C travels sufficiently slowly while traversing route 332 that sensor data and position data can be accurately captured for particular position(s). In some embodiments, mobile sensor platform(s) 102A, 102B and/or 102C travels at a velocity that allows for multiple sensor data points for each map feature (described below). Mobile sensor platform(s) 102A, 102B and/or 102C send sensor and position data to server 150 at 206 (repeating 204) during or after traversing route 330 and/or route 332.

Thus, using method 200, sensor and position data may be captured for regions of a map. The sensor data and position data may be provided to server 150 or other component for processing, aggregation, and analysis. Sensor data and position data are sensed sufficiently frequently using method 200 that variations environmental quality on the hyper-local scales may be reflected in the sensor data. Method 200 may be performed using a relatively small number of mobile sensor platforms. Consequently, efficiency of data gathering may be improved while maintaining sufficient sensitivity in both sensor and position data.

In some embodiments, the system accurately classifies leaks based on pollutant signals detected above a sensor noise baseline. A particular pollutant may arise from different types of sources. For example, release of methane may be caused by a thermogenic source (e.g., a fossil fuel-derived source) or by a biogenic source (e.g., a biological source, such as bacteria). The system processes the sensor data to detect pollutant signals in the sensor data to properly classify a pollutant (e.g., to properly attribute the pollutant to a particular source type). For example, a utility customer may only be interested in leaks over a geographic area that arise from thermogenic sources because the utility customer can redirect maintenance resources to identified leaks to the locations at which the leaks are detected. If the source type is not accurately classified, the utility customer may improperly deploy maintenance resources to a source over which it has no control (e.g., a biogenic source such as plant-animal material, landfill emissions, wetlands, etc.).

In some embodiments, the system infers the source type for detected methane based on whether the sensor data comprises a co-occurrence of ethane. Thermogenic methane sources (e.g., typically natural gas leaks) are distinguished from biogenic sources based on the co-occurrence of enhanced ethane levels in a fixed proportion. In contrast, biogenic methane occurs solely because it is generated by bacteria that only produces methane with no ethane.

According to various embodiments, despite an unstable baseline, the obtained ethane signals exhibit hyper-local enhancements. Various embodiments implement a baseline-subtracting model configured to capture only the exhibit hyper-local enhancements. Instead of the raw ethane concentration, the baseline-subtracted enhancement can then be treated as a “modality”, propagated through aggregation steps (e.g., passes, segment median, etc.), and can be categorized into a pollutant intensity of a “low”, “medium”, or “high” classification.

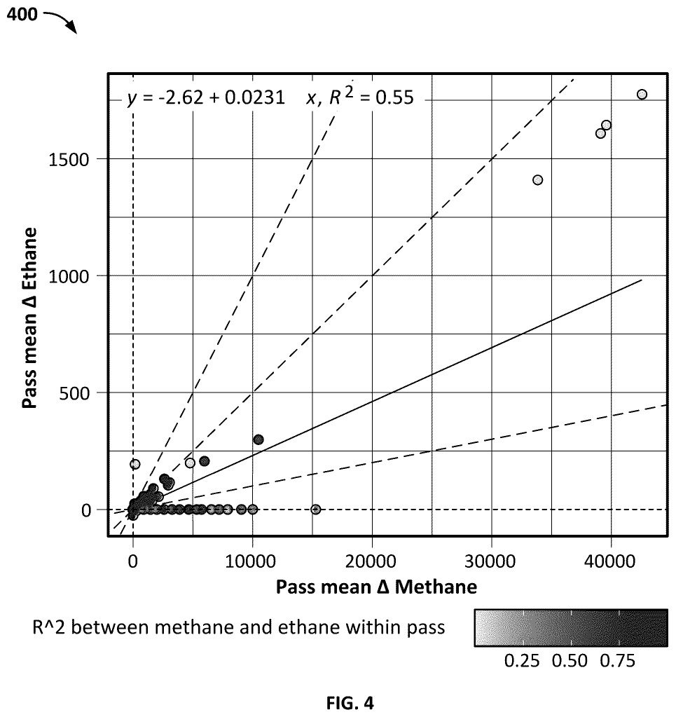

FIG. 4 illustrates a relationship between methane and ethane signals in collected sensor data according to various embodiments. Representation 400 shows the mean level/change of methane relative to the mean level/change of ethane. For every sampling at a particular location, the sensor data comprises a correlation between ethane and methane enhancements (e.g., signals for the ethane and methane). The system may discard signals occurring with enhanced carbon monoxide based on the assumption that such signals are attributable to automobile sources (e.g., not leaks in infrastructure carrying the gas). As illustrated, the amount of ethane present in sensor data for thermogenic sources is really small. Methane levels may have an intensity on the order of thousands, while ethane levels have an intensity on the order of hundreds. Because of the minimal ethane detections, the system may falsely classify a source as thermogenic based on detecting an ethane signal that is attributable to sensor noise.

In various embodiments, the system determines the inherent sensor noise in the sensors (e.g., the set of mobile sensors that perform sampling over the geographic region). The system accurately classifies the pollutant source type despite large contributions of sensor noise in the collected sensor data. For example, the system tunes the detection probability or probability of a false positive.

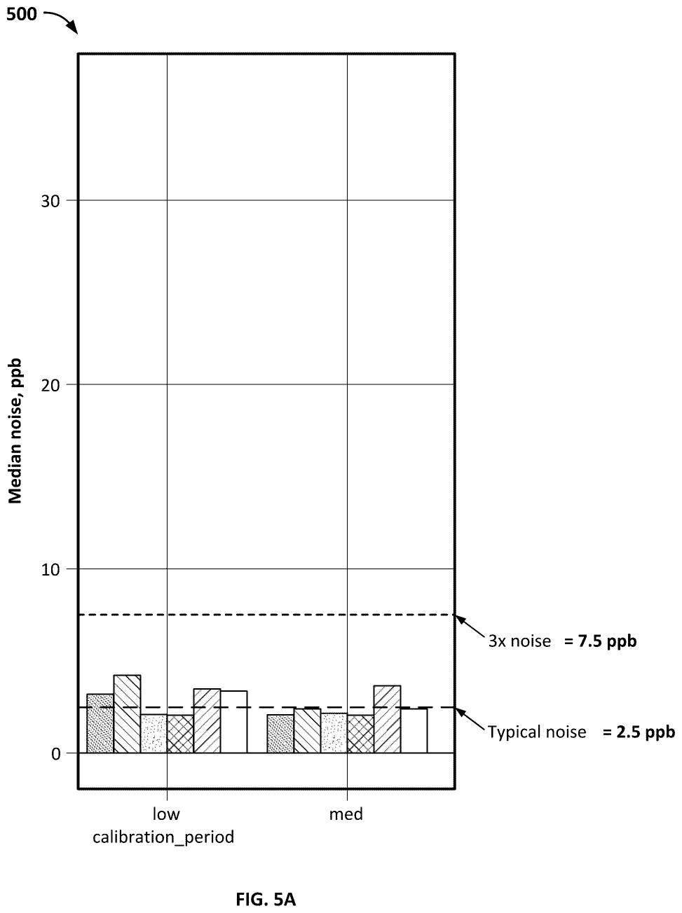

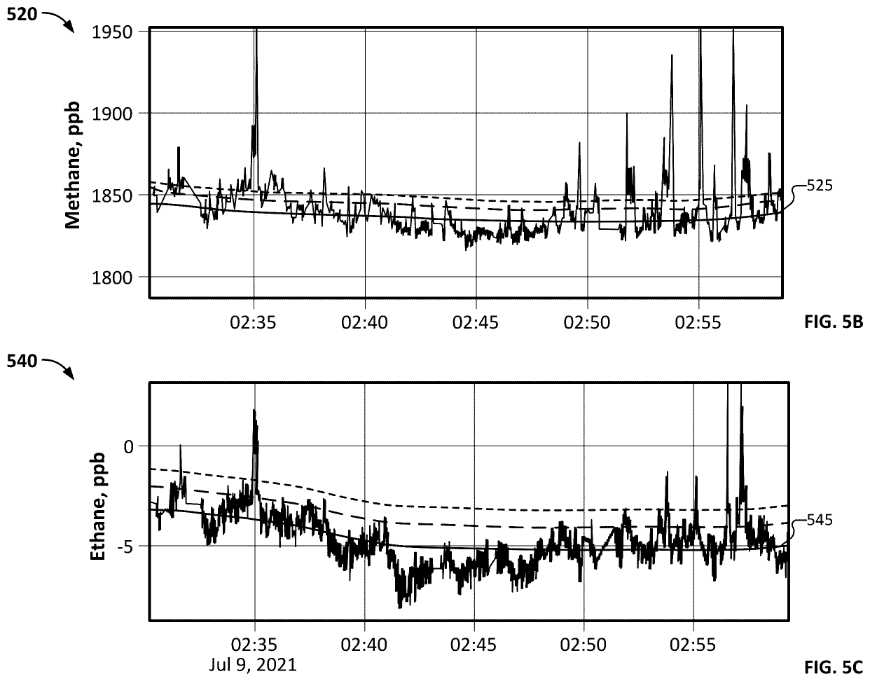

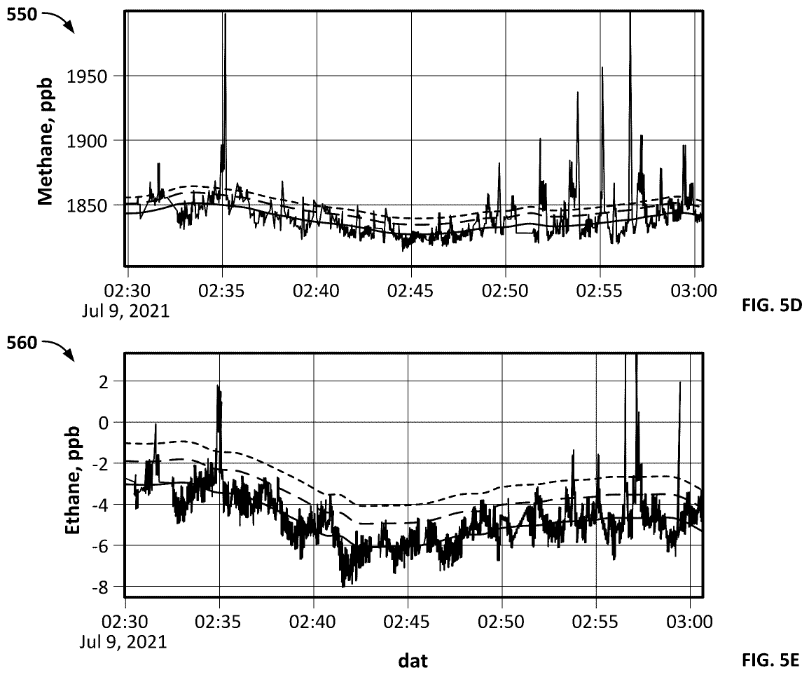

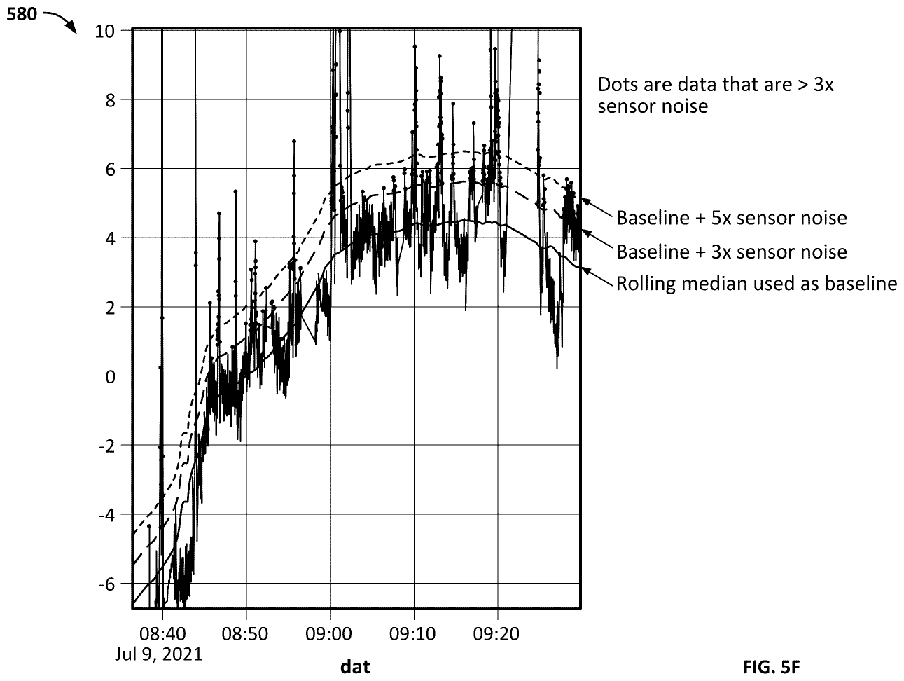

FIG. 5A illustrates an example of a calibration of a set of sensors according to various embodiments. In the example shown, calibration representation 500 shows the observed noise across a set of sensors for different periods of time. Each bar represents a different sensor with the same sensors being analyzed for the different calibration time periods. For example, the leftmost bar for the graph of observed data during low calibration time periods is the same sensor as the leftmost bar for the graph of observed data during high calibration time periods. The calibration of the sensors shown in FIG. 5A may correspond to a particular pollutant, such as ethane. In both a low calibration period and a medium calibration period, the observed noise is approximately 2.5 parts per billion. In some embodiments, the system determines a statistical-value (e.g., average, median, etc.) of the noise observed across the set of sensors and deems the statistical value as the sensor noise baseline.

In some embodiments, the system calibrates the sensors by exposing the set of sensors to a particular pollutant at a particular pollutant intensity, obtaining the sensor data collected by the set of sensors, and controlling for the known pollutant contributions to derive the sensor noise.

The system accurately classifies the pollutant source by detecting pollutant signals that are statistically relevant while accounting for the sensor baseline. In some embodiments, the system classifies the pollutant source based on using a pollutant signal having an intensity that is greater than the sensor noise baseline by a predetermined absolute amount. In some embodiments, the system classifies the pollutant source based on using a pollutant signal having an intensity that is greater than the sensor noise baseline by a predetermined extent. An example of a predetermined extent used to identify pollutant contributions that are not attributable to sensor noise is three times the sensor noise baseline. Various other predetermined extents may be implemented (e.g., two times the sensor noise baseline, two and a half times the sensor noise, etc.).

In some embodiments, the system uses a rolling sensor noise baseline, such as a rolling median baseline. The rolling median sensor noise baseline may be adjusted by tuning the window (e.g., time period) over which the median sensor noise baseline is computed. The system may tune the window based on a measure of fit between the rolling median sensor noise baseline and the signal comprised in the sensor data.

FIGS. 5B and 5C illustrate examples of a rolling baseline signals according to a first time window relative to methane and ethane signals according to various embodiments. As illustrated, the rolling median sensor noise baseline 525 for methane shown in graph 520 and the rolling median sensor noise baseline 545 for ethane shown in graph 540 do not closely fit the signal. As an example, the window used to compute rolling median sensor noise baseline 525 and rolling median sensor noise baseline 545 may be twenty minutes. The system may adjust the window to capture a better fit between the sensor noise baseline and the signal. For example, the system adjusts the window over which the rolling median sensor noise baselines are computed to be five minutes.

FIGS. 5D and 5E illustrate examples of a rolling baseline signals according to a second time window relative to methane and ethane signals according to various embodiments. As illustrated, the rolling median sensor noise baseline 555 for methane shown in graph 550 and the rolling median sensor noise baseline 565 for ethane shown in graph 560 more closely fit the signal compared to graphs 520 and 540 of FIGS. 5B and 5C. In other words, tuning the window, such as by shortening the window from twenty minutes to five minutes results in a baseline that better captures the neighborhood-scale variations in the signal.

FIG. 5F illustrates an example of an ethane signal relative to various baselines according to various embodiments. In the example shown, graph 580 illustrates a signal 582 collected in the sensor data and a rolling median sensor noise baseline 584, which closely fits signal 582. Example pollutant thresholds 586, 588 that can be used to detect pollutant contributions to the signal are shown. For example, the system uses a pollutant threshold that is statistically relevant or otherwise significantly higher than the rolling median sensor noise baseline in order to avoid false positives.

In response to receiving sensor data, the system extracts the pollutant signal by isolating the pollutant contribution from the sensor noise, such as by counting as detections of the pollutant those measurements having a pollutant intensity greater than the pollutant threshold relative to the rolling median sensor noise baseline. In some embodiments, the system classifies the source type for a first pollutant signal (e.g., a methane signal) based at least in part on the observed second pollutant signal (e.g., the ethane signal), if any. For example, the system determines that ethane is detected as a co-occurrent with methane based at least in part on determining that the observed ethane measurement has an intensity greater than the pollutant threshold (e.g., three times the sensor noise baseline). In response to determining that the second pollutant (e.g., ethane) is co-occurring with the first pollutant (e.g., methane), the system determines that the source type for the first pollutant source is thermogenic. Conversely, if the first pollutant is observed without a statistically significant observation of the second pollutant, the system determines that the source type for the first pollutant source is biogenic.

In some embodiments, in response to classifying the source type for pollutants, the system can map observed leaks across a geographic area or pollutants emitted based on biogenic sources. A utility customer can use the map of leaks to deploy maintenance resources. A municipality or regulatory agency may use a map of pollutants arising from biogenic sources in connection with determining the impact of biogenic sources or otherwise remediating the area to lessen the biogenic contributions to the atmosphere.

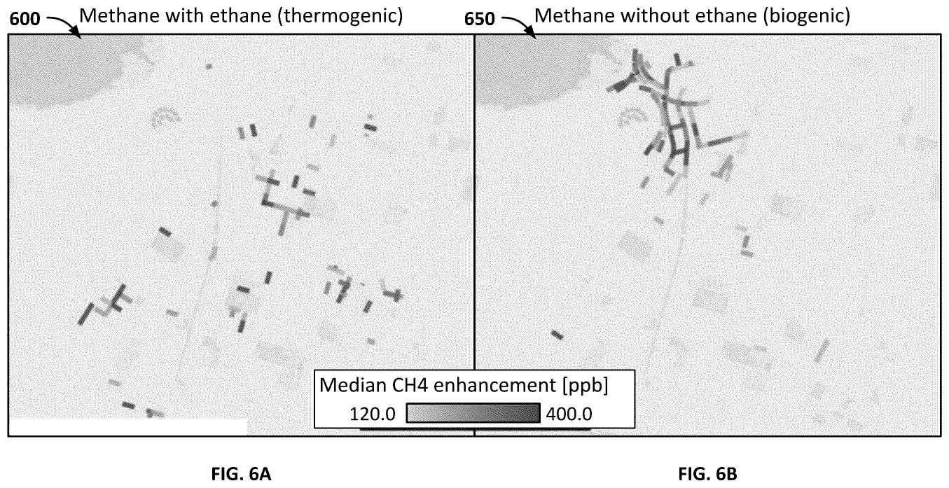

FIGS. 6A and 6B illustrate an example of a map comprising methane signals from different source types according to various embodiments. In the example shown, map 600 illustrates leaks (e.g., methane that is observed in conjunction with an ethane signal). Map 650 illustrates methane observations that arise from a biogenic source. The emphatically displayed road segments correspond to observations.

In some embodiments, if the pollutant intensity (e.g., methane enhancement) is too small (e.g., smaller than a predefined threshold or otherwise deemed not statistically relevant) for the system to identify the methane detection, the system does not classify the methane detection. The system can use the number of unique days that a pollutant is detected at a particular location as a good measure with which to characterize a detection/leak, such as in connection with determining whether to classify the pollutant. For example, the number of unique days on which the system observes a pollutant large enough to be classified can be used as an indicator of the source persistence. The system can further characterize the detection leak based on a hit rate for detecting a pollutant at a particular location, such as a road segment-level hit rate. The system computes the road segment-level hit rate as the number of detections of the pollutant having an intensity large enough to be classified divided by the number of total samplings made at that segment (e.g., the number of drive passes of a vehicle carrying the one or more mobile sensors). The hit rate can be used as an indication of the persistence of the source and/or the detection probability.

In some embodiments, the system represents the detections on a map. For example, the system generates a map comprising an indication of detections that may be labeled (e.g., color coded) according to the number of unique days on which the system observes the pollutant large enough to be classified. As another example, the system generates a map comprising an indication of detections that may be labeled (e.g., color coded according to hit rate). The hit rate can be characterized as “low”, “medium”, or “high” which each have a corresponding ranges of hit rates.

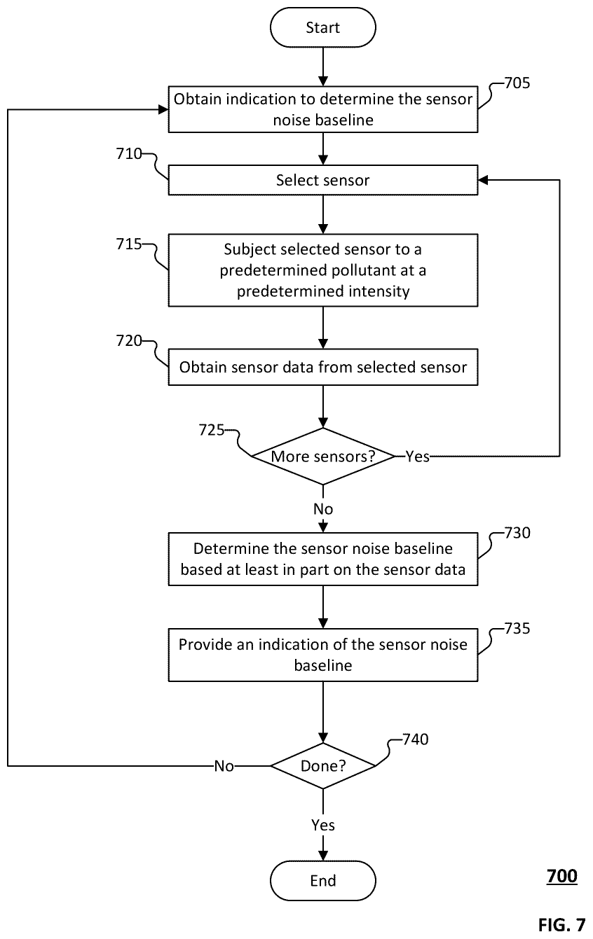

FIG. 7 illustrates a method for calibrating a sensor according to various embodiments. In some embodiments, process 700 is implemented at least in part by system 100 of FIG. 1. Process 700 may be implemented in connection with calibrating a sensor (e.g., a sensor of a particular sensor type).

At 705, the system obtains an indication to determine a sensor noise baseline.

At 710, a sensor is selected.

At 715, the system causes the selected sensor to be subjected to a predetermined pollutant at a predetermined intensity. In some embodiments, the predetermined pollutant is methane. Various other pollutants may be used. The pollutant may be selected based at least in part on the pollutant for which the system is to detect and classify leak states.

At 720, the system obtains sensor data from the selected sensor. For example, the system obtains the sensor data that is generated while the sensor collects measurements as it is subjected to the predetermined pollutant. At 725, the system determines whether the sensor noise baseline is to be determined for additional sensors. In response to determining that the sensor noise baseline is to be determined for additional sensors, process 700 returns to 710 and process 700 iterates over 710-720 until the system determines that no further sensor noise baselines are to be determined. In response to determining that no further sensor noise baselines are to be determined, process 700 proceeds to 730. At 730, the system determines the sensor noise baseline based at least in part on the sensor data. In some embodiments, the system determines the sensor noise baseline based on a statistical analysis of sensor data obtained from a set of sensors (e.g., a same type of sensor). For example, the sensor noise baseline is deemed to be the average sensor noise across the set of sensors. As another example, the sensor noise baseline is deemed to be a median of the sensor noise across the set of sensors. As another example, the sensor noise baseline is a statistically relevant measure of noise expected to be inherent in the sensors based on the behavior of the set of sensors.

At 735, the system provides an indication of the sensor noise baseline. The system may provide the indication of the sensor noise baseline to another system or service, such as a system or service that invoked process 700. As an example, the system provides the sensor noise baseline to a system/service configured to detect leaks, classify leaks, predict leak states, etc.

At 740, a determination is made as to whether process 700 is complete. In some embodiments, process 700 is determined to be complete in response to a determination that no further sensors are to be analyzed, no further sensor noise baselines are to be determined, no further analysis of sensors are to be performed with respect to other pollutants, an administrator indicates that process 700 is to be paused or stopped, etc. In response to a determination that process 700 is complete, process 700 ends. In response to a determination that process 700 is not complete, process 700 returns to 705.

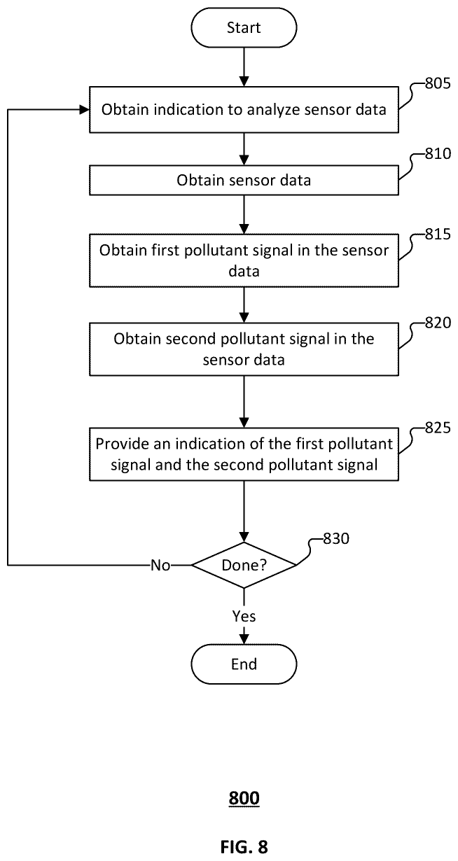

FIG. 8 illustrates a method for determining obtaining different pollutant signals in sensor data collected from a sensor(s) according to various embodiments. In some embodiments, process 800 is implemented at least in part by system 100 of FIG. 1.

At 805, the system obtains an indication to analyze sensor data.

At 810, the system obtains sensor data. The sensor data may be collected by one or more mobile sensors (e.g., a sensor platform(s) mounted to a vehicle(s)). For example, the sensor data corresponds to a particular sampling, such as a drive day on which the vehicle drove a corresponding road segment and performed a sampling (e.g., collected air quality/pollutant measurements).

At 815, the system obtains a first pollutant signal in the sensor data. The system may obtain the first pollutant signal from an indication provided by 735 of process 700. Additionally, or alternatively, the system may analyze the sensor data to extract the first pollutant signal comprised in the sensor data (e.g., determines contributions of a first pollutant within the

At 820, the system obtains a second pollutant signal in the sensor data. The system may obtain the first pollutant signal from an indication provided by 735 of process 700.

At 825, the system provides an indication of the first pollutant signal and the second pollutant signal. In some embodiments, the system provides indication(s) of the first pollutant signal and the second pollutant signal to a system or service configured to classify a source type associated with a particular pollutant (e.g., the first pollutant).

At 830, a determination is made as to whether process 800 is complete. In some embodiments, process 800 is determined to be complete in response to a determination that no further leak data is to be provided, no further air quality measurements are to be collected, no further leaks are to be analyzed, no further pollutant signals are detected, no further pollutant signals are to be provided, an administrator indicates that process 800 is to be paused or stopped, etc. In response to a determination that process 800 is complete, process 800 ends. In response to a determination that process 800 is not complete, process 800 returns to 805.

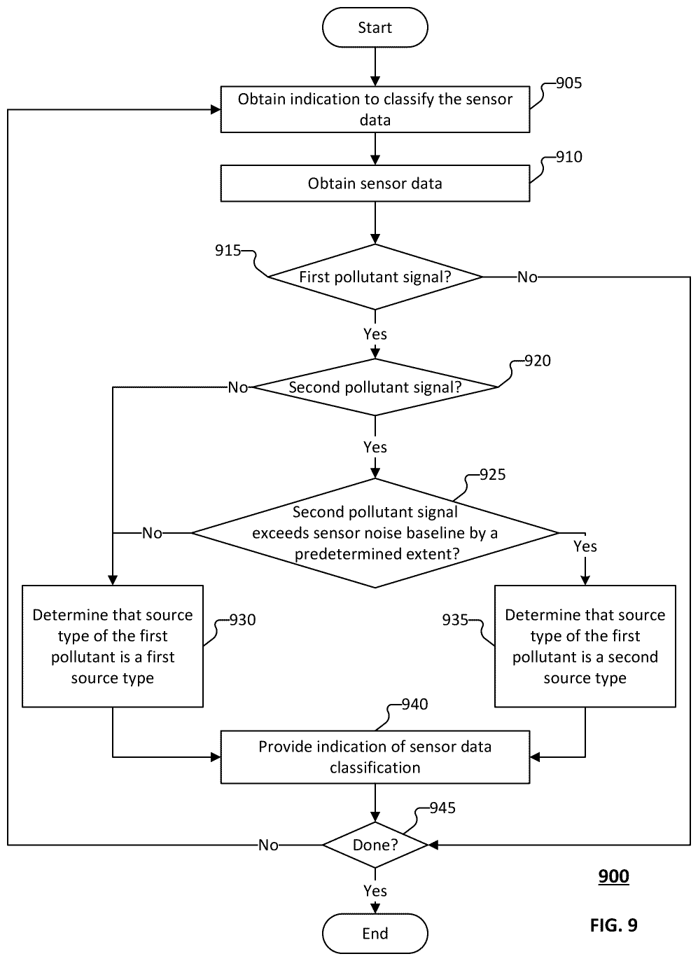

FIG. 9 illustrates a method for classifying a source type for a pollutant based on sensor data according to various embodiments. In some embodiments, process 900 is implemented at least in part by system 100 of FIG. 1. The system may infer a source type based on the presence/co-occurrent of a particular pollutant. For example, in the case that the system is to classify a source of methane, the system analyzes whether ethane is co-occurring (e.g., at sufficient levels above the sensor noise baseline). The system infers the source type to be thermogenic, or derived from fossil-fuels transportation/use, based on the co-occurrence of enhanced ethane levels (e.g., in a fixed proportion). Conversely, the system infers the source type to be biogenic in the absence of any/sufficient ethane because biogenic methane occurs solely because it is generated by bacteria or other biological matter that produces ethane without the co-occurrence of ethane.

At 905, the system obtains an indication to classify the sensor data. For example, the system determines to analyze the sensor data to detect pollutant signals and to identify a source type for the pollutants.

At 910, the system obtains the sensor data. Additionally, or alternatively, the system receives an indication of a first pollutant signal and/or a second pollutant signal in the sensor data. For example, the system may receive the indication from the system or service that at 825 of process 800.

At 915, the system determines whether the sensor data comprises a first pollutant signal. The first pollutant signal may correspond to collected measurements for a particular pollutant, such as a pollutant being monitored. In some embodiments, the first pollutant is methane. In response to determining that the sensor data does not comprise the first pollutant signal, process 900 proceeds to 945. Conversely, in response to determining that the sensor data comprises a first pollutant (e.g., methane), process 900 proceeds to 920.

At 920, the system determines whether the sensor data comprises a second pollutant signal. The second pollutant signal may correspond to collected measurements for another particular pollutant, such as another pollutant that has a correlation with the first pollutant. In response to determining that the sensor data does not comprise the second pollutant signal, process 900 proceeds to 930. Conversely, in response to determining that the sensor data comprises the second pollutant signal, process 900 proceeds to 925.

At 925, the system determines whether the second pollutant signal exceeds a sensor noise baseline by a predetermined extent. The system may obtain the sensor noise baseline from 735 of process 700. The system may determine a sensor noise baseline for a particular type of sensor. The sensor noise baseline may be updated periodically (e.g., to detect drift) or in response to determining an anomaly in measurements collected from the sensor data. In some embodiments, the sensor noise baseline may be a rolling median for sensor noise. The time window over which the rolling median is computed may be five minutes. In some embodiments, the time window over which the rolling median is computed is less than twenty minutes. Various other time windows may be used, and configuration of the time window may be used to tune the sensitivity of the model for identifying a baseline that better fits the signal in the sensor data.

In some embodiments, the predetermined extent is a threshold relative to the noise sensor baseline. As an example, the predetermined extent is three times the sensor noise baseline. As another example, the predetermined extent may be two times the sensor noise baseline. However, various other relative values may be implemented. Alternatively, the predetermined extent may correspond to an absolute value greater than the sensor noise baseline.

In response to determining that the second pollutant signal in the sensor data does not exceed the sensor noise baseline by a predetermined extent, process 900 proceeds to 930 at which the system determines that the source type of the first pollutant is a first source type. For example, in response to determining that the amount of the second pollutant measured is either none or less than the predetermined threshold/extent, the system deems the source of first pollutant to be a particular source type. In some embodiments, the first pollutant is methane, and the second pollutant is ethane. In response to detecting methane in the absence of any or sufficient levels of ethane, the system determines that the source type of the first pollutant is a biogenic source type (e.g., arising from biological matter).

In response to determining that the second pollutant signal in the sensor data exceeds the sensor noise baseline by the predetermined extent (e.g., by a fixed proportion), process 900 proceeds to 935 at which the system determines that the source type of the first pollutant is a second source type. For example, the system infers the source type to be a second source type in response to detecting sufficient co-occurrence of the first pollutant and the second pollutant. In some embodiments, the first pollutant is methane, and the second pollutant is ethane. In response to determining that ethane sufficiently co-occurs with methane, the system infers the source type to be a thermogenic source type (e.g., that the methane is derived from fossil fuels).

In response to determining the source type, process 900 proceeds to 940. At 940, the system provides an indication of the sensor data classification. For example, the system classifies the source type of the first pollutant and provides the classification. The indication may be provided to another system or service. For example, the system may determine to provide the indication to a mapping service that maps leaks across a geographic area being monitored.

At 945, a determination is made as to whether process 900 is complete. In some embodiments, process 900 is determined to be complete in response to a determination that no further leak data is to be provided, no further air quality measurements are to be collected, no further leaks are to be analyzed, no further source types of a particular pollutant are to be classified, an administrator indicates that process 900 is to be paused or stopped, etc. In response to a determination that process 900 is complete, process 900 ends. In response to a determination that process 900 is not complete, process 900 returns to 905.

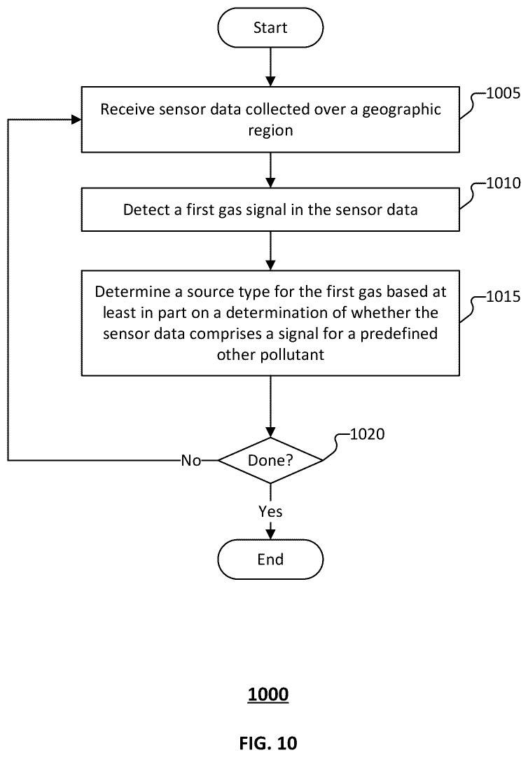

FIG. 10 illustrates a method for determining a source type for a first gas detected based on sensor data according to various embodiments. In some embodiments, process 1000 is implemented at least in part by system 100 of FIG. 1.

At 1005, the system receives sensor data collected of a geographic region. The geographic region may be a predefined area over which air quality (e.g., pollutant levels) are monitored, such as a contracted area with a particular customer (e.g., a municipality, a utility, etc.). At 1010, the system detects a first gas signal in the sensor data. The first gas signal may be methane. In some embodiments, detecting the first gas signal includes determining that an intensity of methane in the sensor data is greater than a predefined threshold and/or sustained for a predetermined time period. In some embodiments, the system determines that the first gas signal is detected in the sensor data in response to determining that the sensor data is indicative of a leak. At 1015, the system determines a source type for the first gas based at least in part on a determination of whether the sensor data comprises a signal for a predefined other pollutant. In some embodiments, the system classifies the source for the first gas (e.g., methane) as thermogenic, or fossil fuel-derived, based on the determination that the first gas co-occurs with another pollutant such as ethane. The system provides the source types to another system or service. For example, a mapping service that monitors leaks from thermogenic sources may use the source type classification to properly identify the corresponding leak on a map over the geographic area. As another example, the mapping service may map leaks for different source types and provide different labelling or indicators of the source type. At 1020, a determination is made as to whether process 1000 is complete. In some embodiments, process 1000 is determined to be complete in response to a determination that no further leak data is to be provided, no further air quality measurements are to be collected, no further leaks are to be analyzed, no further source types of a particular pollutant are to be classified, an administrator indicates that process 1000 is to be paused or stopped, etc. In response to a determination that process 1000 is complete, process 1000 ends. In response to a determination that process 1000 is not complete, process 1000 returns to 1005.

In some embodiments, a set of mobile sensors (e.g., mobile sensors mounted to a fleet of one or more vehicles) is deployed to an air quality collection session. The set of mobile sensors are deployed to measure air quality (e.g., detect pollutant levels, etc.) across a geographic area (e.g., a contracted area). The set of mobile sensors generally does not sample everywhere at all times during each session. Further, during each sampling (e.g., driving on a road segment and collecting an air quality measurement) leaks are not detected one hundred percent of the time. For example, leaks are generally detected about fifty to sixty percent of the number of times the location is sampled (e.g., the detection probability). Further, some detection of some leaks much lower, such as five percent of the time. The leak detection probability can vary at different locations based on characteristics of the particular location, such as geography, topography, wind profile, time of day (e.g., a leak signal may experience interference during rush hour when a significant number of automobiles emit pollutants), underground structure, infrastructure (e.g., the type of assets/pipelines used to carry a particular gas), etc.

In some embodiments, the system generates a model of each leak (e.g., a detected leak). The model includes setting a status of the leak at different times based on the information available. Given that the leak detection probability is less than one hundred percent and that each leak has its own characteristic frequency, the system uses a statistical/probabilistic model to assess the leak status (e.g., determine whether to update the status to inactive, etc.).

The system may use a predefined detection probability (e.g., a probability that is determined based on historical sensor data) or an average detection probability for all leaks (e.g., all leaks within the geographic region for all time that sensor data is available; all current leaks; all leaks within the geographic region over a predetermined time period; etc.). However, using the predefined or average detection probability is susceptible to erroneously turning off a leak (e.g., setting the leak as inactive) or turning on the leak. For example, if the average detection probability of fifteen percent is implemented and the leak is detected in sensor data for a percentage of time that is significantly higher than the average detection probability (e.g., a leak is detected at a much higher probability or a leak is detected at a much lower probability), then the model for the leak (e.g., the model for setting the status of the leak) would be surprised.

The average detection probability may be determined in accordance with Equation 1, where λ represents the average detection probability. Such an average detection probability does not take into account the effect detection probability has on number of leaks detected, or the effect the driving intensity has on a number of leaks detected.

$$λ = \frac{road segments on which a leak is detected}{total road segments} \qquad ( 1 )$$

As an illustrative example, if the model uses an average detection probability of twenty percent and a particular leak has an actual detection probability of five percent, then the model would expect to detect a leak once out of every five times, but the actual detection probability would lead the system to detect the leak once out of every twenty times the location was sampled. Accordingly, because the system expects to detect the leak once every five samplings but actually detects the leak once every twenty samplings the system may prematurely close out the leak (e.g., set the leak to inactive or to a no-leak state). Further, the system may open up multiple leaks for a particular leak over a time period when the leak has persisted over the entire time but was prematurely closed out for non-detection according to the expected rate.

In some embodiments, the system implements different detection probabilities for different leaks. Rather than the model assuming one detection probability, various embodiments configure the model to be able to adapt/adjust the detection probability. Determining a detection probability for a subset of leaks (e.g., a different detection probability for each leak) allows the system to overcome the problem where leaks that do not have an average/median detection probability behavior are not shut off (e.g., set to inactive or a no-leak state) too early or too late. In some embodiments, the model customizes (e.g., determines) the leak probability for each leak (e.g., the leak for which the model is configuring the leak state). The model may be configured to allow the leak detection probability for a particular leak vary between a range of detection probabilities. The model selects a detection probability that is most consistent with the observed data (e.g., the sensor data). The model thus makes a selection/determination of a leak detection probability rather than using a pre-selected detection probability across all leaks. The detection probability is a valuable manner to characterize leaks. For example, larger leaks generally have higher detection probabilities.

In connection with determining a leak state for a particular leak, the mode determines whether the leak is more likely to still be on (e.g., a leak-on state) or more likely to be turned off (e.g., a no-leak state) despite the sensor data not comprising a recent sampling at the particular location (e.g., a sub-region associated with a cluster for the leak). For example, the system uses an estimate of the historical detection rate of the leak. In some embodiments, the model uses a long range of historical sensor data and a set of recent sampling data to determine the leak state for a leak.

In some embodiments, the model is a Hidden Markov Model (HMM). The HMM uses a period from the last detection and determines the probability of getting the same detection reading in a row given that historically the system can estimate the detection probability based on past detections (e.g., all detections in the past). As an example, the HMM returns a value of 1 for an indication that a leak is active and returns a value of 0 for an indication that the leak is inactive.

Once the model determines that the leak is most probably shut off (e.g., repaired), the system sets the leak state to be inactive. If a subsequent leak is detected at the same location of the leak that was set to inactive, then the system deems the new leak detection to be associated with a new leak. In some embodiments, the system associates a set of leaks that happen in the same location/area. The sensitivity of the model in turning off leaks (e.g., deeming the leak to be inactive) may be tuned between a relatively conservative model in which the model may wait too long to turn the leak off (e.g., deem the leak as inactive). For example, even when the system knows that the leak is likely shut off, the conservative model is configured to wait for a lot of evidence (e.g., non-detections) before turning the leak off. Such a relatively conservative model thus creates a delay in the ability to assess the leak. Conversely, the model may be configured to more quickly turn leaks off (e.g., be more eager to turn the leaks off), which can result in a single leak being broken up into a series of separate leaks.

In some embodiments, the system analyzes historical leaks to assess whether the leak was turned off (e.g., deemed inactive) too early. For example, the system looks to observations made after the leak was turned off to assess whether the leak was turned off too early, or whether the observations corresponded to a series of separate leaks. The system may use the analysis of historical leaks in connection with tuning the model or otherwise providing an update to a leak profile (e.g., information used by a customer or regulatory authority to determine the extent of the leak).

In some embodiments, the system uses three states to classify inputs to the model used to determine a leak state. The three states include a leak-on state, a no-leak state, and an unsampled state (e.g., no measurement was collected for the particular location at the particular time). The system queries the model (e.g., the HMM) to determine the leak state. Over a period of time that the particular location remains unsampled, the model smooths the observations between the leak-on state and the no-leak state (e.g., the inactive leak). For example, if a leak is detected and then the location remains unsampled over a period of time, during that period of time, the leak probability (e.g., the probability that a leak exists) decays over time and eventually the model deems the leak inactive, and the system sets the leak to the no-leak state.

In some embodiments, the system uses the model to determine how far or close a change in leak state is expected to occur. For example, the system determines the time at which a leak having a leak-on state is deemed inactive and set to a leak-state. The predicted time of the leak state transition may be based at least in part on the inferred leak probability. The system can use this predicted time of the leak state transition in connection with determining drive plans or plans to sample the particular location. For example, if the predicted time of the leak state is close (e.g., within a predefined time threshold), the system can more heavily weight the particular location (e.g., the road segment) in the model for selecting locations to be sampled during a session. Sampling the location temporally close to the predicted time of the leak state transition allows for a more accurate determination of the time at which the leak is shut off. For example, the model has a greater uncertainty associated with the leak probability for times that are temporally close to the predicted leak transition state. Conversely, the system may assign a low weight to a particular location at which the predicted leak transition time is greater than a threshold period of time.

The model may be configured with a hard cut-off (e.g., six months) for transitioning an active leak to an inactive leak. For example, if the system determines a leak is active and the location remains unsampled for a cut-off period of time, the system deems the leak to be inactive.

In some embodiments, the system jointly estimates the detection probability and the probability and regional leak probability, utilizing the number of leaks detected and the sampling intensity. The probability of a leak for various locations within a geographic area may be used to rank regions based on how bad the system expects the leaks to be. The system can use the ranking in connection with determining drive plans (e.g., routes/plans for sampling different locations during a session) or updating a map of leaks across a geographic region.

In various embodiments, the system models the road segment level observation process as a mixture of a leak and no-leak components, including detection probability. For example, the system determines the detection probability according to Equations 2-6.

P(dᵢ)=λP(dᵢ|nᵢ,lᵢ=1)+(1−λ)P(dᵢ|nᵢ,lᵢ=0) (2)

lᵢ˜Bernoulli(λ) (3)

P(dᵢ|nᵢ,lᵢ=1)˜Binomial(nᵢ,θᵢ) (4)

P(dᵢ|nᵢ,lᵢ=0)˜Binomial(nᵢ,0) (5)

θᵢ˜Beta(α,β) (6)

The system may estimate λ, α, and β in Equations 2-6 above using Markov Chain Monte Carlo (MCMC) or Variational Inference (VI), which are generally available in various programming languages such as Python. In Equations 2-6, dᵢ(observed) is the number of detections on a road segment i, nᵢ(observed) is the number of passes on the road segment i, lᵢ(partially observed) is the presence of a leak on segment i, λ is the probability of any segment having a leak, and θᵢ is the probability of detecting a leak if the leak is present. In some embodiments, the model uses α and β to determine θ, and λ and θ to predict the detected state.

In some embodiments, the system determines the leak probability (or leak probability distribution) based at least in part on one or more of a probability that a detected leak is a false positive, a probability that a detected leak is true (e.g., that the detected leak is actually a leak), a probability that a detected non-leak is a false negative (e.g., the non-leak detection should be a detected leak), and a probability that a non-leak is true (e.g., that the detected non-leak is actually a non-leak). The system accounts for false positives or false negatives among the detections by using information (e.g., detection probabilities, etc.) across a plurality of road segments. For example, the system shares information about the detection ratio on certain road segments at which leaks were detected to try to estimate the number of road segments for which no leaks are detected but that actually have a leak (e.g., based on the available sensor data for the particular location being a relatively small sample set). The system can model road segments with no detections as coming from a similar detection probability distribution as selected road segments for which the system has detected leaks.

The model weighs the number of detections versus the number of samplings (e.g., collected measurements) for a particular location, and uses a binomial function to obtain a probability distribution.

TABLE 1

| | | | Number of | |
|---|---|---|---|---|
| | | pdp (detection | Passes (e.g., | Number of |
| Road Segment | Cluster | probability) | samplings) | Detections |
| A | 1 | 0.1 | 10 | 1 |
| B | — | — | 9 | 0 |
| C | 2 | 0.2 | 8 | 2 |

In the illustrative example in Table 1, the system determines that road segment B has no detections. However, the fact that the sensor data does not indicate any detections for road segment B is not conclusive that no leak exists because the detection probability is not one hundred percent. Accordingly, the system uses the model to predict for road segment B a detection probability or a leak probability given that the sensor data has no detections for road segment B. In some embodiments, the system uses the detection probability or a leak probability for one or more of road segments A and C to predict the detection probability or a leak probability for road segment B. The system can use this information to then set the leak state for road segment B. In some embodiments, the system weighs the contributions for the various road segments used to predict a detection probability for a particular road segment. The weights may be determined based on various factors, such as distance between the road segment and the particular road segment for which the detection probability is being predicted, location characteristics (e.g., geography, topography, wind profile, time of day that sample were collected, infrastructure carrying the gas such as a type of pipe, etc.), etc. In some embodiments, the system selects road segments to use in connection with predicting a detection probability for a particular road segment based on the road segments having a minimum degree of similarity in road segment profiles/characteristics.

The system can use the model to estimate the occurrence rate at which road segments leak in a region while adjusting for the sampling intensity. For example, some locations within a geographic area are being sampled more often than other locations (e.g., the locations to be sampled are probabilistically determined for a particular session).

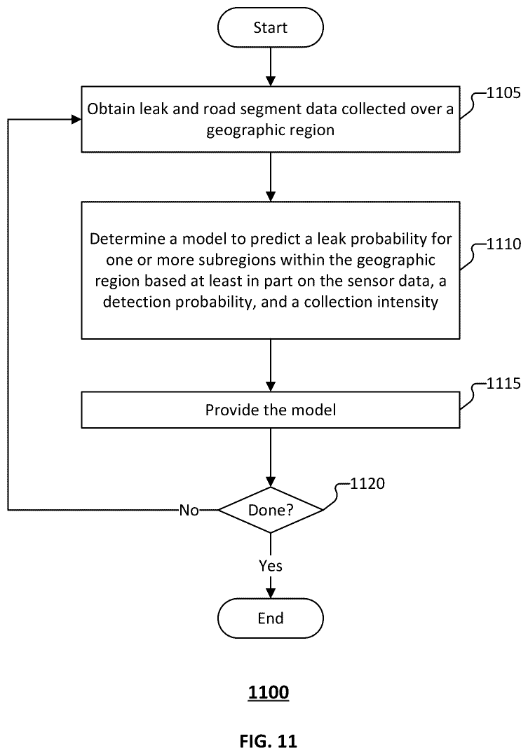

FIG. 11 illustrates a method for providing a model to predict a leak probability at various locations within a predefined geographic area according to various embodiments. In some embodiments, process 1100 is implemented at least in part by system 100 of FIG. 1.

At 1105, the system obtains leak and road segment pass data collected over a geographic region. The leak data is generated by the system described previously (e.g., the clustering and querying of the HMM model).

At 1110, the system determines a model to predict a leak probability for one or more subregions within the geographic region. The model may predict the leak probability based at least in part on the sensor data, a detection probability, and a collection intensity.

At 1115, the model is provided. In some embodiments, the system provides the model to another system or service that invoked 1115, such as a service that is configured to determine states for active leaks, leak inactivity, etc. or a service that is configured to generate a map of leaks across a geographic region.

At 1120, a determination is made as to whether process 1100 is complete. In some embodiments, process 1100 is determined to be complete in response to a determination that no further leak data is to be provided, no further air quality measurements are to be collected, no further leaks are to be analyzed, an administrator indicates that process 1100 is to be paused or stopped, etc. In response to a determination that process 1100 is complete, process 1100 ends. In response to a determination that process 1100 is not complete, process 1100 returns to 1105.

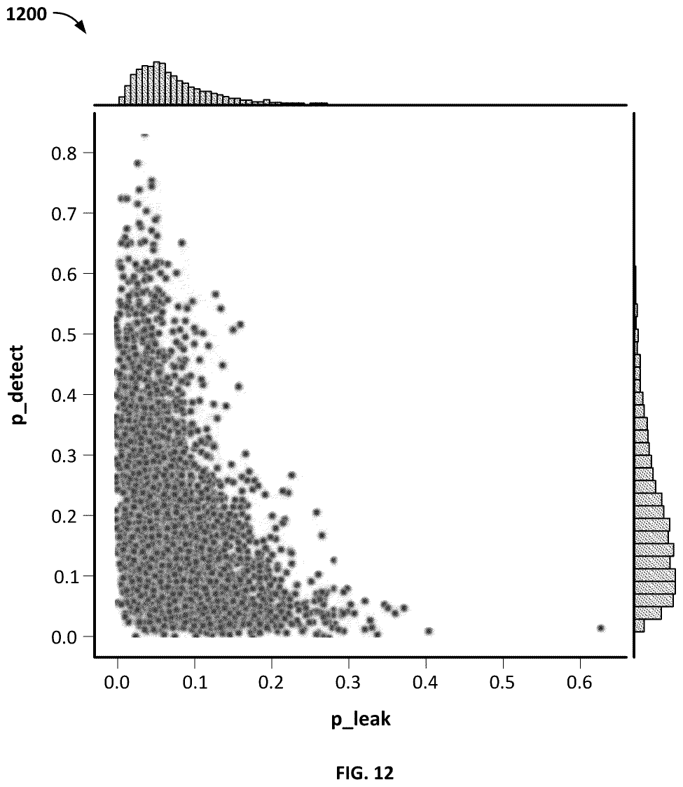

FIG. 12 illustrates a relationship between a detection probability distribution and a leak probability distribution according to various embodiments. Representation 1200 shows that the detection probability distribution is coupled to the leak probability distribution. Based on the relationship in the example shown, if the model/system does not account for the probability of detection, then the system will not accurately measure the probability of a leak at a particular location.

In some embodiments, the system analyzes sensor data to identify detections of a pollutant being monitored across a geographic regions. The system may cluster detections across the geographic region into distinct leaks. Further, the system may determine clusters at a same particular location at statistically significant time periods as different leaks occurring at or near the same location.

In response to determining that the sensor comprises a set of pollutant measurements corresponding to detections, the system clusters the set of pollutant measurements. The system may set the peak of the geographically proximal pollutant observations (e.g., the measurement having the highest pollutant intensity) as the center of the cluster. The system may set a subregion of the geographic area as being associated with a particular leak (e.g., a particular cluster). For example, the system deems the cluster to be a subregion defined by an area that radially extends by a predefined distance from the center of the cluster. The predefined distance may be configured to tune the sensitivity of the model for detecting different leaks. If the predefined distance is set too large, then a subregion may be defined sufficiently large to encompass a plurality of clusters/leaks. Conversely, if the predefined distance is set too small, then the subregion may exclude observations that are actually associated with the leak corresponding to the subregion. Further the system may falsely identify a different leak using such observations outside the subregion. In some embodiments, the predefined distance is between 10 and 20 meters. In some embodiments, the predefined distance is 15 meters.

In connection with identifying the leaks, the system isolates detections corresponding to a particular source type(s). For example, to identify leaks (e.g., from a gas pipeline) the system determines detections corresponding to biogenic sources and excludes those detections from the model for identifying leaks across the geographic region.

According to various embodiments, the system identifies leaks and dynamically updates the corresponding leak statuses based one or more of current sensor data or probabilistically/statistically using detection probability distributions, leak distributions, and historical sensor data for the leaks, etc. The system implements a model that predicts a leak state for a leak. For example, the model classifies the leak as either leak-on or inactive (e.g., shut off). The model may be an HMM. In some embodiments, the inputs to the model are classified according to one of three states: leak-on, inactive or no-leak, and unsampled (e.g., no collected sensor data for the corresponding location at the particular session or point in time).

The model used to predict the leak state for a leak is configured such that a leak is more likely to transition from a leak-on state (e.g., an active state) to a no-leak state (e.g., an inactive state) than the leak is to transition from a no-leak state to a leak state. Accordingly, over time the model eventually settles an active leak to an inactive state. The system can tune the model to more quickly transition from a leak-on state to a no-leak state in the absence of new sensor data for the particular location or in the absence of detections from sensor data at the particular location. For example, the system tunes the number of samplings performed at the location for which no detection is registered before the transitioning the active leak to an inactive leak. In some embodiments, the model accounts for repair data, such as a record of repairs in the geographic area that may be obtained from a third-party service, such as a local utility.

Determining a leak start date and a leak end date (e.g., a date/time at which an active leak transitions to an inactive leak) can be used to determine the gross amount of pollution that occurred during the leak lifespan. For example, municipalities or regulatory agencies may be interested in knowing the precise leak lifespan in order to determine an amount of a fine to levy against the utility responsible for the leak. Currently utilities determine the leak lifespan by inferring the leak started from the date/time of the last measurement for which the system did not detect the pollutant. Various embodiments use statistically derived leak start dates and leak end dates to precisely predict the leak lifespan, thus shortening the time period for which the utility is considered responsible for the leak (e.g., the true leak lifespan that is statistically predicted is generally shorter than the current methods for measuring the leak lifespan).

Related art systems use a peak to pass ratio in connection with determining whether to transition an active leak to an inactive leak. The peak to pass ratio may be computed as the number of detections made over the number of times the location was sampled. Such systems can also use a peak to pass ratio for all-time sensor data (e.g., samplings made over a predefined historical period of time) versus the peak to pass ratio for a set of recent samplings (e.g., samplings made within a threshold period of time). The related art systems could then derive a trend that may be occurring for a particular leak.

The model according to various embodiments is more responsive and better supported from a data analysis perspective than the crude related art systems. Sensor data is input to the model and the model dynamically updates the leak state for leaks within the geographic area. The system may probabilistically determine the leak states. As an example, the system may identify newly detected leaks based on observed sensor data and the corresponding detection probability distribution associated with the location(s) at which the leak is detected. As another example, the system may determine to transition an active leak to an inactive leak based on the detection probability, the leak probability, and the sensor data (e.g., both historical sensor data and recent sensor data).

In some embodiments, if a first leak at a particular location transitions from a leak-on state to an inactive state, and a second leak is subsequently detected at the same location, the system deems the first leak and the second leak as distinct leaks. However, the system may associate the first leak and the second leak based on the occurrence at the same location, such as to provide an indication of a location at which the infrastructure (e.g., gas pipelines) are susceptible to leaks, etc.

The system generates a map of a geographic region (e.g., a region for which the system is contracted to monitor over a particular time period) in which the various leaks are indicated. The map may comprise an indication of whether a particular leak is an active leak or a recently inactive leak (e.g., a leak that transitioned to inactive within a threshold period of time). The map may represent detections of a particular pollutant on a per road segment basis. For example, the system may display the pollutant detection on the per road segment basis in manner that labels the detection according to pollutant intensity (e.g., low intensity detections may be color coded as green, medium intensity detections may be color coded as yellow, high intensity detections may be color coded as red, or the pollutant intensity can be color coded along a predefined spectrum).

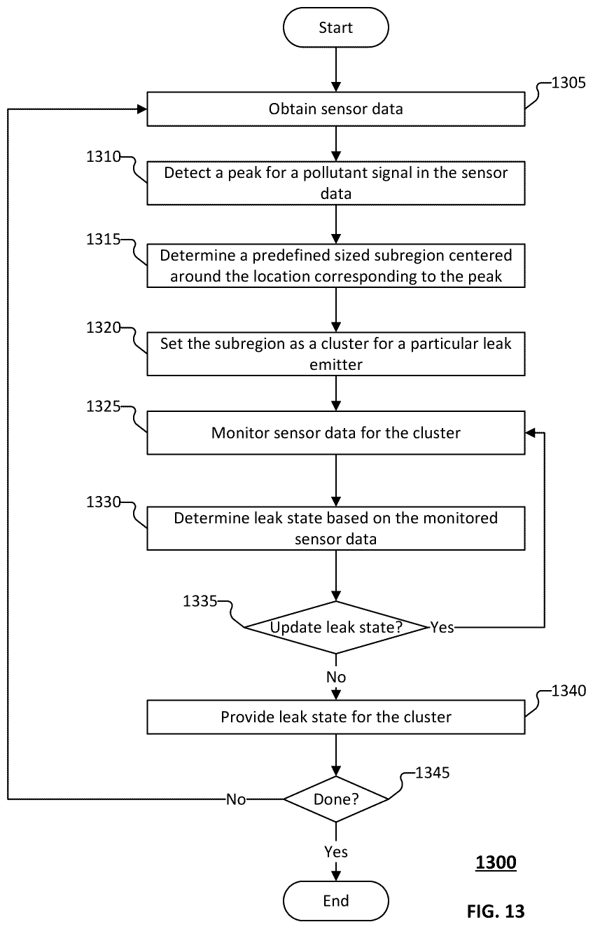

FIG. 13 illustrates a method for determining a leak state for a cluster according to various embodiments. In some embodiments, process 1300 is implemented at least in part by system 100 of FIG. 1.

At 1305, the system obtains sensor data. The sensor data may be collected by one or more mobile sensors (e.g., a sensor platform(s) mounted to a vehicle(s)). For example, the sensor data corresponds to a particular sampling, such as a drive day on which the vehicle drove a corresponding road segment and performed a sampling (e.g., collected air quality/pollutant measurements).

At 1310, the system detects a peak for a pollutant signal in the sensor data. The pollutant signal may be a particular pollutant being monitored, such as methane, ethane, etc. process 1300 may be implemented a plurality of times respectively corresponding to an analysis of different pollutants. In some embodiments, the system detects the peak based on a determination that the pollutant signal intensity exceeds a threshold level, such as the sensor noise baseline or a threshold set relative to the sensor noise baseline (e.g., three times the sensor noise baseline).

At 1315, the system determines a predefined sized subregion centered around the location corresponding to the peak. For example, if the system determines that peak corresponds to a leak and that the leak is not an existing leak, the system may determine to form a new subregion for a new cluster of sensor data. The predefined sized subregion may be a circular area radially extending from a center location (e.g., the location of the peak). For example, the predefined subregion is an area that radially extends 15 meters (or another predefined distance threshold) from the center.

At 1320, the subregion is set as a cluster for a particular leak emitter. The system deems the subregion as corresponding to a leak and collects sensor data for the subregion (e.g., as the area is sampled) to monitor the leak, such as to determine if the leak is ongoing or inactive (e.g., repaired).

At 1325, the system monitors sensor data for the cluster. As sensor data sampled in the subregion is collected, the system updates the model and updates or maintains the leak status (e.g., a leak state, a no-leak state, an unsampled state) based on the sensor data.

At 1330, the system determines a leak state based on the monitored sensor data. For example, the system determines (e.g., by querying a model for a predicted leak classification or leak probability) whether to maintain the leak state or whether to set the status to a no-leak state or an unsampled state. The system may determine to set the status to an unsampled state in response to determining that the no sampling (or an extent of a sampling is less than a sampling threshold) has been performed within the subregion.

At 1335, the system determines whether to update the leak state. For example, the system determines whether to continue monitoring the leak. In response to determining the leak state, process 1300 returns to 1325 and process may iterate over 1325-1330 until the system determines that the leak state is to no longer be updated.

At 1340, the system provides the leak state for the cluster. The system can provide the leak state to another system or service that invoked process 1300, such as a mapping service that generates a map of leaks across a geographic area being monitored.

At 1345, a determination is made as to whether process 1300 is complete. In some embodiments, process 1300 is determined to be complete in response to a determination that no further leak data is to be provided, no further air quality measurements are to be collected, no further leaks are to be analyzed or classified, no further peaks are detected, an administrator indicates that process 1300 is to be paused or stopped, etc. In response to a determination that process 1300 is complete, process 1300 ends. In response to a determination that process 1300 is not complete, process 1300 returns to 1305.

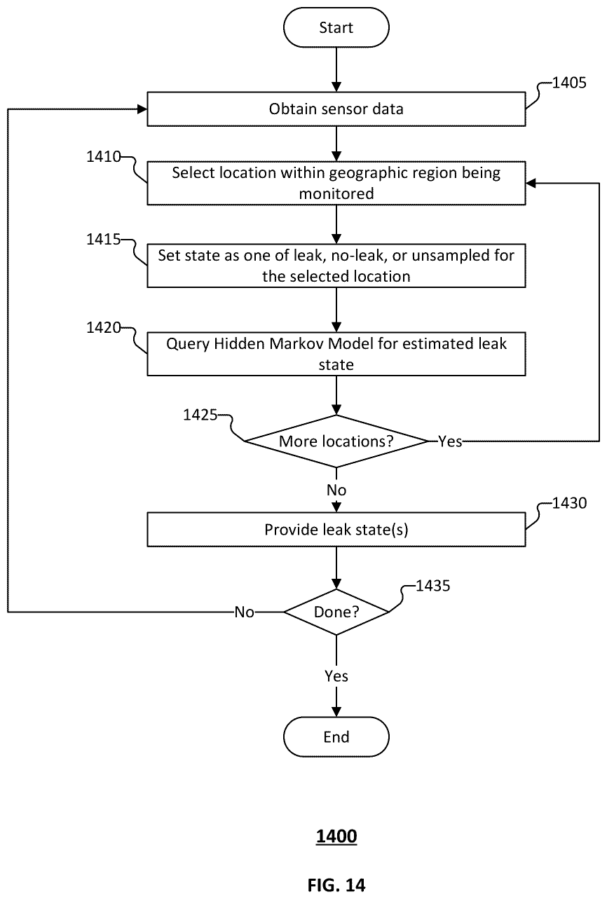

FIG. 14 illustrates a method for determining a leak state for a particular leak according to various embodiments. In some embodiments, process 1400 is implemented at least in part by system 100 of FIG. 1.

At 1405, the system obtains sensor data. The sensor data may be collected by one or more mobile sensors (e.g., a sensor platform(s) mounted to a vehicle(s)). For example, the sensor data corresponds to a particular sampling, such as a drive day on which the vehicle drove a corresponding road segment and performed a sampling (e.g., collected air quality/pollutant measurements).

At 1410, the system selects a location within the geographic region being monitored. For example, the system determines a location corresponding to sensor data (e.g., a location at which the mobile sensor platform sampled/collected the air quality measurement).

At 1415, the system sets the state for the detections (e.g., the sensor data) at the selected location as one of a leak state, a no-leak state, or an unsampled state. The system sets the state based at least in part on the sensor data. For example, in response to determining that the location has not been sampled over a predefined time threshold (or the sampling of the location is less than a predefined sampling threshold), the system may deem the state to be the unsampled state. As another example, the system determines to set the state to the leak state in response to determining that a pollutant signal is detected (e.g., a pollutant signal having an intensity greater than an intensity threshold, such as a threshold set relative to a sensor noise baseline). As another example, the system determines to set the state to the no-leak state in response to determining that a pollutant signal is not detected or that the detected pollutant signal is less than the intensity threshold (e.g., a level at which the pollutant signal may be attributable to inherent sensor noise.

At 1420, the system queries a model for an estimated leak state. For example, the system queries the model for a predicted leak classification or a predicted leak probability (e.g., a probability that a leak exists at the selected location). The model may be a Hidden Markov Model (HMM) that uses historical and current sensor data for the selected location and/or locations in proximity to the selected location to predict a leak state. The locations in proximity to the selected location may correspond to locations within a threshold distance of the selected location and/or locations deemed to have a similar location characteristics (e.g., topography, wind, underlying infrastructure from which the leak may be emitted such as a type of pipe carrying the gas, etc.).

At 1425, the system determines whether to estimate the leak state at more locations within the geographic area. For example, the system may iterate over the various locations (e.g., road segments, census tracts, etc.) in connection with mapping leaks across the geographic region. In response to determining that the leak state is to be estimated at more locations, process 1400 returns to 1410 and process 1400 iterates over 1410-1420 until the system is to not estimate the leak state at any further locations. Conversely, in response to determining that the system is to not estimate the leak state at any further locations, process 1400 proceeds to 1430.

At 1430, the system provides the leak state. In some embodiments, the system provides the leak state to another system or service (e.g., a mapping service that maps leaks across the geographic area being monitored) that invoked process 1400. For example, the system provides an alert to a user or other system or service that a new leak has been detected. As another example, the system updates a map of detected leaks across the geographic area being monitored. The system may use the indication of the leak state(s) in connection with determining drive plans (e.g., plans for sampling at the particular location) or requesting a repair.

At 1430, a determination is made as to whether process 1400 is complete. In some embodiments, process 1400 is determined to be complete in response to a determination that no further leak data is to be provided, no further air quality measurements are to be collected, no further leaks are to be analyzed, an administrator indicates that process 1400 is to be paused or stopped, etc. In response to a determination that process 1400 is complete, process 1400 ends. In response to a determination that process 1400 is not complete, process 1400 returns to 1405.

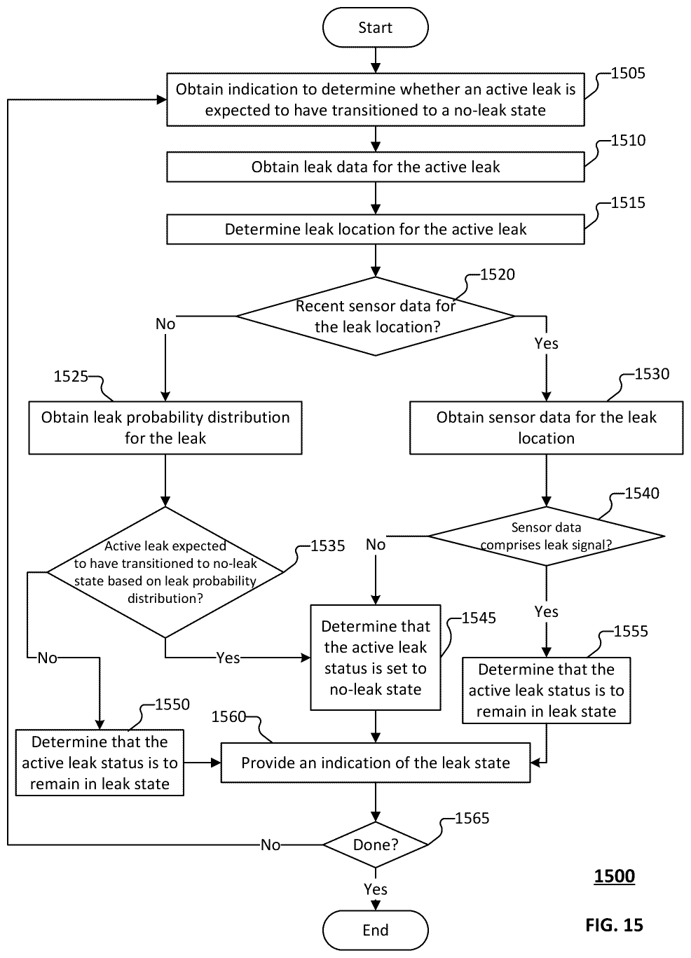

FIG. 15 illustrates a method for determining a leak state for a particular leak according to various embodiments. In some embodiments, process 1500 is implemented at least in part by system 100 of FIG. 1.

At 1505, the system obtains an indication to determine whether an active leak is expected to have transitioned to a no-leak state. The leak probability for a particular leak may decrease over time in the absence of further detections for the corresponding location (e.g., the subregion for the leak cluster).

At 1510, the system obtains leak data for the active leak. For example, the system obtains the measurements (e.g., leak detections or leak non-detections) for the leak over a predetermined period of time.

At 1515, the system determines a leak location for the active leak. For example, the system determines the subregion associated with the active leak or an estimated source of the leak (e.g., the emitter).

At 1520, the system determines whether the sensor data for the leak location comprises recent sensor data. The system may determine whether the leak location has been sampled within a predefined period of time. The predefined period of time may be configurable such as to adjust the sensitivity of the model (e.g., the sensitivity with respect to whether the model is to classify the leak as inactive) in the absence of leak detections.

In response to determining that the leak location (e.g., the subregion corresponding to the cluster for the leak) has not been sampled recently (e.g., no recent sensor data exists for the leak location) at 1520, process 1500 proceeds to 1525 at which the system obtains the leak probability distribution for the leak. The leak probability distribution may be determined based at least in part on historical input states (e.g., leak state, no-leak state, unsampled state) for data at the leaked location.

In response to determining that the leak location has been sampled recently (e.g., that recent sensor data exists for the leak location) at 1520, process 1500 proceeds to 1530 at which the system obtains the sensor data for the leak location. The system may obtain the historical sensor data, including the recent sensor data collected for the leak location.

At 1535, the system determines whether the active leak is expected to have transitioned to a no-leak state based at least in part on the leak probability distribution. For example, the system queries a model (e.g., a Hidden Markov Model) for an estimated leak state (e.g., a predicted leak classification). For example, the model determines whether the leak is more likely to still be on despite not having been detected recently or whether the leak is more likely to have been deactivated (e.g., repaired and set as an inactive leak). The system may determine the predicted leak classification despite a leak having been seen recently, such as based on estimate of the historical detection rate for the leak or similar leaks, such as leaks occurring at similar locations (e.g., similar topographies, weather, wind profile, underlying infrastructure carrying the pollutant such as type of pipes—cast iron, plastic, etc.).

In response to determining that the active leak is expected to have transitioned to a no-leak state (e.g., that the predicted leak probability is less than a predefined leak threshold), process 1500 proceeds to 1545. Conversely, in response to determining that the active leak is not expected to have transitioned to the no-leak state (e.g., become inactive), process 1500 proceeds to 1550.

At 1540, the system determines whether sensor data comprises a leak signal. For example, the system determines whether the sensor data for the leak location is indicative of the presence of a particular pollutant (e.g., the pollutant being monitored such as methane). In some embodiments, the system determines that the sensor data comprises a leak signal in response to determining that the detected pollutant signal exceeds a threshold, such as a predefined threshold or a predefined extent relative to the sensor noise baseline (e.g., three times the sensor noise baseline). In response to determining that the sensor data does not comprise the leak signal, process 1500 proceeds to 1545. Conversely, in response to determining that the sensor data comprises the leak signal, process 1500 proceeds to 1555.

At 1545, the system determines that the active leak status is set to no-leak state.

At 1555, the system determines that the active leak status is to remain in the leak state.

At 1560, the system provides an indication of the leak state. The indication of the leak state may be provided to another system or service, such as a system/service that invoked process 1500 (e.g., a mapping service that maps leaks over a geographic region being monitored) or a third-party system (e.g., a regulatory authority or customer, etc.). In some embodiments, the system provides the indication of the leak state to a regulatory authority or a customer in connection with the monitoring of leaks over a geographic area.

At 1565, a determination is made as to whether process 1500 is complete. In some embodiments, process 1500 is determined to be complete in response to a determination that no further leak data is to be provided, no further air quality measurements are to be collected, no further leaks are to be analyzed, an administrator indicates that process 1500 is to be paused or stopped, etc. In response to a determination that process 1500 is complete, process 1500 ends. In response to a determination that process 1500 is not complete, process 1500 returns to 1505.

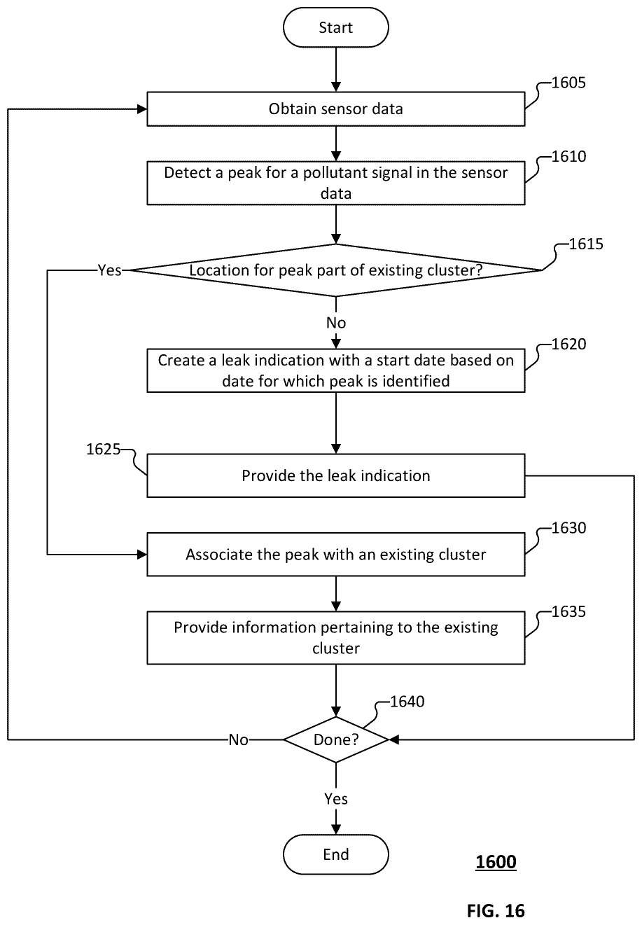

FIG. 16 illustrates a method for associating detected peaks in the sensor data with a new or existing cluster associated with a particular leak according to various embodiments. In some embodiments, process 1600 is implemented at least in part by system 100 of FIG. 1.

At 1605, the system obtains sensor data. The sensor data may be collected by one or more mobile sensors (e.g., a sensor platform(s) mounted to a vehicle(s)). For example, the sensor data corresponds to a particular sampling, such as a drive day on which the vehicle drove a corresponding road segment and performed a sampling (e.g., collected air quality/pollutant measurements).

At 1610, the system detects a peak for a pollutant signal in the sensor data. The pollutant signal may be a particular pollutant being monitored, such as methane, ethane, etc. process 1600 may be implemented a plurality of times respectively corresponding to an analysis of different pollutants. In some embodiments, the system detects the peak based on a determination that the pollutant signal intensity exceeds a threshold level, such as the sensor noise baseline or a threshold set relative to the sensor noise baseline (e.g., three times the sensor noise baseline).

At 1615, the system determines whether the geographic location for the peak in the pollutant signal is part of an existing cluster. For example, the system determines whether the geographic location corresponding to the sampling of sensor data from which the pollutant signal peak is detected is within the subregion associated with a cluster. The subregion may be a predefined size, such as an area that radially extends 15 meters from the center of the cluster. Various other cluster sizes may be implemented. For example, the size of the subregion for a particular cluster may be tunable to control sensitivity of the detection model. If the subregion is made too large, then multiple leaks may be clustered and identified as a single leak. Conversely, if the subregion is made too small, then pollutant signal leaks sampled closely outside the subregion may be classified as separate leaks (e.g., a false positive).

In response to determining that the location for the peak in the pollutant signal is not part of an existing cluster, process 1600 proceeds to 1620 at which the system creates a leak indication. The system may associate a start date with the leak indication, the start date corresponding to the date of the sensor data in which the peak is detected/identified (e.g., the first date on which a pollutant signal is detected for a particular location for a distinct leak). Thereafter, process 1600 proceeds to 1625 at which the leak indication is provided. For example, the system provides an alert to a user or other system or service that a new leak has been detected. As another example, the system updates a map of detected leaks across the geographic area being monitored. The system may use the indication of the new leak in connection with determining drive plans (e.g., plans for sampling at the particular location) or requesting a repair.

In response to determining that the location for the peak in the pollutant signal is part of an existing cluster, process 1600 proceeds to 1630 at which the system associates the pollutant signal leak (e.g., the sensor data for the particular location) with an existing cluster. The system determines a cluster having a subregion within which the location for the sensor data in which the pollutant signal peak is detected. Thereafter, at 1635, the system provides information pertaining to the existing cluster. For example, the system provides an alert to a user or other system or service that the corresponding leak persists. As another example, the system updates a map of detected leaks across the geographic area being monitored. The system may use the indication of the leak in connection with determining drive plans (e.g., plans for sampling at the particular location) or requesting a repair.

At 1640, a determination is made as to whether process 1600 is complete. In some embodiments, process 1600 is determined to be complete in response to a determination that no further leak data is to be provided, no further air quality measurements are to be collected, no further leaks are to be analyzed, an administrator indicates that process 1600 is to be paused or stopped, etc. In response to a determination that process 1600 is complete, process 1600 ends. In response to a determination that process 1600 is not complete, process 1600 returns to 1605.

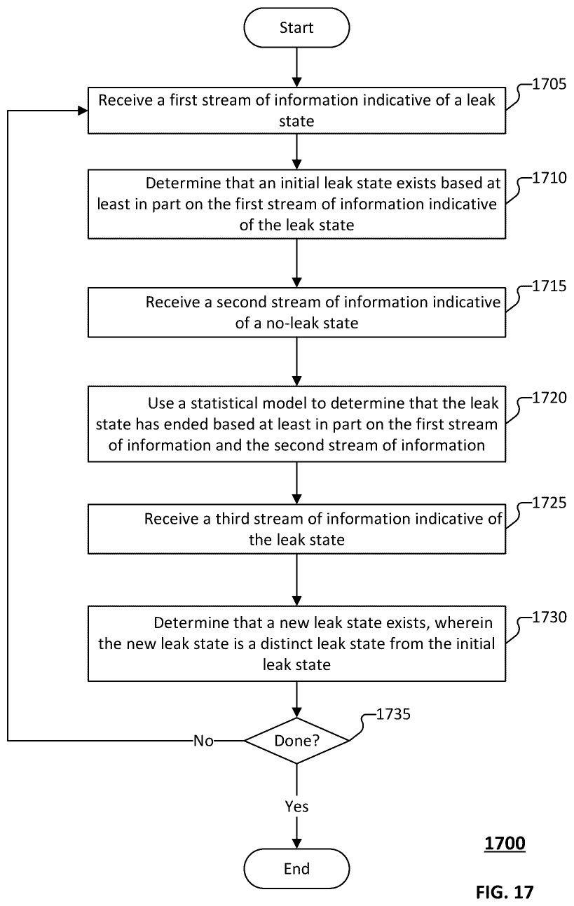

FIG. 17 illustrates a method for detecting leaks according to various embodiments. In some embodiments, process 1700 is implemented at least in part by system 100 of FIG. 1.

In some embodiments, process 1700 is implemented for one or more pollutants being monitored. For example, process 1700 is implemented to control the activation and inactivation of leak indicators for methane. Various other pollutants may be monitored.

At 1705, the system receives a first stream of information indicative of a leak state. In some embodiments, the sensor data comprising the first stream of information is collected by one or more mobile sensors (e.g., collected by a sensor platform mounted to a vehicle that drives a predefined drive plan). The first stream of information may correspond to information for a particular location, such as a subregion corresponding to a cluster of peaks for a leak signal detected.

At 1710, the system determines that an initial leak state exists. The system determines that the initial leak state exists at a particular location (e.g., a subregion associated with a cluster of leak detections that correspond to a single emitter/leak source) based at least in part on the first stream of information. The system may determine that the initial leak state exists based at least in part on a determination that the location(s) at which the leak detection is collected does not correspond to a cluster associated with an existing leak.

In some embodiments, the system may determine that the initial leak state exists based at least in part on querying a model for a prediction of a leak classification, such as a leak probability. In the event that the leak probability exceeds a predefined leak threshold, the system deems a leak to exist at the corresponding location/subregion within the geographic region being monitored.

At 1715, the system receives a second stream of information. The second stream of information is indicative of a no-leak state (e.g., for the particular location associated with the initial leak, such as a subregion for a cluster). For example, the sensor data collected at the particular location/subregion associated with the initial leak does not comprise a pollutant signal (e.g., no peaks for a particular pollutant). The system may deem the sensor data to not comprise a pollutant signal if a detected pollutant has an intensity less than a predefined threshold, such as a sensor noise baseline.

At 1720, the system uses a statistical model to determine that the leak state has ended based at least in part on the first stream of information and the second stream of information. For example, the model provides a predicted leak classification or a predicted leak probability. In response to querying the model to obtain the predicted leak classification or the predicted leak probability, the system determines whether the leak state has ended.

In some embodiments, the model is a Hidden Markov Model (HMM). The HMM receives an input corresponding to sampling of a particular location or subregion (e.g., a subregion associated with the leak, such as an area extending radially 15 meters from the center of the cluster, etc.). The input to the HMM is classified according to one of three states: leak, no-leak (or non-leak), and unsampled (e.g., the location has not been visited. In response to the query for the leak classification (e.g., either based on a query from another service or according to a periodic update of a leak indication or map of leaks over the geographic area), the HMM provides a predicted leak classification as either a leak state or a no-leak state.

At 1725, the system receives a third stream of information. The third stream of information is indicative of a leak state (e.g., for the particular location associated with the initial leak, such as a subregion for a cluster). The system may determine that the third stream of information is indicative of a leak state based on the presence of a leak signal (e.g., a signal for a particular pollutant being monitored, such as methane) having an intensity that exceeds a sensor noise baseline by a predefined threshold, such as a sensor noise baseline or a threshold set relative to the baseline (e.g., three times the sensor noise baseline).

At 1730, the system determines that a new leak exists. The new leak is deemed to be distinct from the initial leak. The system determines that a new leak exists based at least in part on the third stream of information. In some embodiments, the system determines that a new leak exists because the initial leak has been closed or otherwise rendered inactive.

In some embodiments, the system queries a model (e.g., the MOM) to determine whether the leak indicated by the third stream of information should be associated with the leak indicated by the first stream of information (e.g., whether the system prematurely inactivating the initial leak and setting to inactive).

In some embodiments, the system determines that the leak indicated by the third stream of information is distinct from the leak indicated by the first stream based at least in part on determining that a repair had been performed to fix the initial leak. For example, the system obtains repair data, such as data received from a third party (e.g., data provided by a utility managing the infrastructure from which the leak was emitted).

In response to determining that the new leak exists, the system provides an indication of the new leak. For example, the system provides an alert to a user or other system or service that a new leak has been detected. As another example, the system updates a map of detected leaks across the geographic area being monitored. The system may use the indication of the new leak in connection with determining drive plans (e.g., plans for sampling at the particular location) or requesting a repair.

At 1735, a determination is made as to whether process 1700 is complete. In some embodiments, process 1700 is determined to be complete in response to a determination that no further leak data is to be provided, no further air quality measurements are to be collected, no further leaks are to be analyzed, an administrator indicates that process 1700 is to be paused or stopped, etc. In response to a determination that process 1700 is complete, process 1700 ends. In response to a determination that process 1700 is not complete, process 1700 returns to 1705.

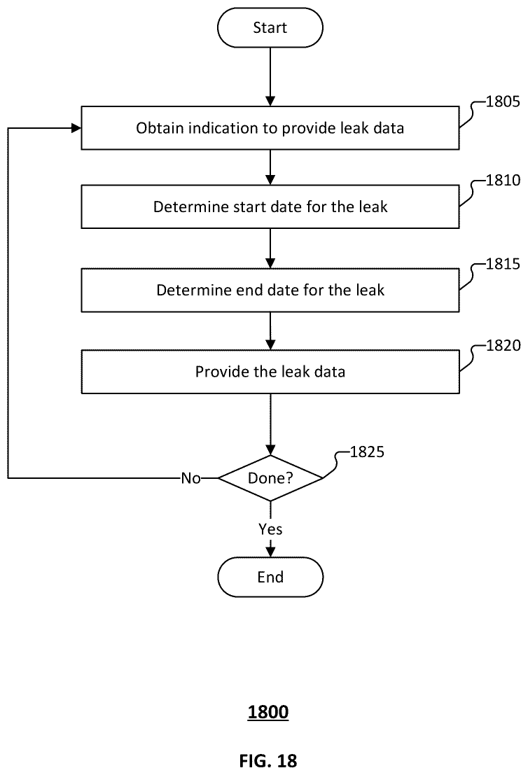

FIG. 18 illustrates a method for providing leak data according to various embodiments. In some embodiments, process 1700 is implemented at least in part by system 100 of FIG. 1.

At 1805, the system obtains an indication to provide leak data for a particular leak.

At 1810, the system determines a start date for the leak. The system determines a start date for the leak based on an earliest date on which a peak for a pollutant signal is observed in sensor data. For example, the system determines a date on which the system identified a leak, such as based on identifying a cluster.

At 1815, the system determines and end date for the leak. In some embodiments, the system determines an end date for the leak based on an earliest date on which the system probabilistically determines that the leak ended. The system may probabilistically determine that the leak ended based on sensor data comprising a set of one or more no-leak state detections. Additionally, or alternatively, the system probabilistically determines that the leak ended based on the region associated with the leak remaining unsampled over a period of time. For example, the system determines a date on which the leak is expected to be resolved (e.g., repaired by a utility, etc.) based on a leak probability and sensor data, which may comprise a set of leak detections, a set of no-leak detections, or set of values associated with the region being unsampled.

In some embodiments, the system determines to transition the leak to an inactive state (e.g., a no-leak state) in response to determining that the leak no longer exists. As an example, the system determines that the leak no longer exists based at least in part on sensor data and/or third-party service data, such as repair data indicating repair activity. The system may probabilistically determine that the leak no longer exists based at least in part on a model of the leak probability. The model for the leak probability predicts a likelihood that a leak exists based at least in part on sensor data (e.g., a set of leak detections, a set of no-leak detections) or a lack thereof (e.g., the region in proximity to the leak is unsampled over a period of time). The system may query the model for a prediction of whether the leak exists. In some embodiments, the system updates or maintains the leak state based at least in part on the prediction.

At 1820, the system provides the leak data. The leak data may be provided to another system or service, such as a system/service that invoked process 1800 (e.g., a mapping service that maps leaks over a geographic region being monitored) or a third-party system (e.g., a regulatory authority or customer, etc.). In some embodiments, the system provides the leak data to a regulatory authority or a customer in connection with the monitoring of leaks over a geographic area. The system may compute an amount of carbon (or a predefined other pollutant) that was emitted into the atmosphere based at least in part on the predicted start date and the predicted end date. The regulatory authority and the customer may use the amount of carbon in connection with computing fees or other compensation owed by the customer (e.g., a utility) for the pollution.

At 1825, a determination is made as to whether process 1800 is complete. In some embodiments, process 1800 is determined to be complete in response to a determination that no further leak data is to be provided, no further air quality measurements are to be collected, an administrator indicates that process 1800 is to be paused or stopped, etc. In response to a determination that process 1800 is complete, process 1800 ends. In response to a determination that process 1800 is not complete, process 1800 returns to 1805.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for detecting leaks near an emitter, comprising:
a processor configured to:
receive, from one or more mobile sensors, a first stream of information indicative of a leak state;
determine that an initial leak state exists based at least in part on the first stream of information indicative of the leak state;
receive a second stream of information indicative of a no-leak state;
use a statistical model to determine that the leak state has ended based at least in part on the first stream of information and the second stream of information;
receive a third stream of information indicative of the leak state; and
determine that a new leak state exists, wherein the new leak state is a distinct leak state from the initial leak state; and
a memory coupled to the processor and configured to provide the processor with instructions.

2. The system of claim 1, further comprising a communication interface configured to receive sensor data from one or more mobile sensors, wherein the first stream of information, the second stream of information, and the third stream of information is obtained based at least in part on the sensor data.

3. The system of claim 1, wherein the initial leak state exists at a particular location within a geographic region monitored by the one or more mobile sensors.

4. The system of claim 3, wherein the processor is further configured to:
determine a state for the particular location corresponds to an unsampled state at a particular time.

5. The system of claim 4, wherein the statistical model is used to detect that the leak state has ended based at least in part on a time series data comprising a first subset of data corresponding to the leak state, a second subset of data corresponding to the no-leak state, and a third subset of data corresponding to the unsampled state.

6. The system of claim 3, wherein the particular location corresponds to particular region corresponding to a cluster of sensor data indicative.

7. The system of claim 1, wherein:
the initial leak state exists at a particular location within a geographic region monitored by the one or more mobile sensors; and
a state for the particular location is probabilistically determined to switch from the leak state to a no-leak state based at least in part on the particular location being unsampled over a period of time.

8. The system of claim 1, wherein the first stream of information indicative of the leak state is obtained based at least in part on performing a clustering with respect to sensor data collected over a geographic region for a period of time.

9. The system of claim 8, wherein the performing the clustering with respect to the sensor data includes determining a cluster of measurements collected in the sensor data around the emitter.

10. The system of claim 1, wherein the processor is further configured to implement a hidden Markov model (HMM) to determine whether a state at a particular location corresponds to the leak state or the no-leak state.

11. The system of claim 1, wherein the processor is further configured to provide an indication of time at which a particular leak started and a time at which a particular leak ended.

12. The system of claim 1, wherein the processor is further configured to classify a source type associated with the leak as a biogenic source type or a thermogenic source type.

13. The system of claim 12, wherein the processor classifies the source type as the biogenic source type, or the thermogenic source type based at least in part on a determination of whether sensor data near the emitter indicates a presence of ethane.

14. The system of claim 1, wherein the initial leak state is determined to exist based at least in part on a detection probability.

15. The system of claim 14, wherein the detection probability includes a leak component corresponding to a probability of detecting a leak, and a no-leak component corresponding to a probability of detecting no leak.

16. The system of claim 1, wherein the processor is further configured to:
determine if a state at a particular location is expected to transition from the leak state to the no-leak state at a particular time; and
update a sampling plan to cause the one or more mobile sensors to sample the particular location within a predefined time period of the particular time.

17. The system of claim 1, wherein the processor is further configured to:
obtain repair data from a third-party service indicating repair activity within a geographic location over which the one or more mobile sensors collect sensor data;
determine whether the repair data indicates that a repair was performed within proximity of the emitter between a time at which the first stream of information is received and a time at which the third stream of information is received; and
in response to determining that the repair was performed within proximity of the emitter, determine that the leak indicated by the third stream of information is distinct from the initial leak.

18. The system of claim 1, wherein the processor is further configured to:
obtain repair data from a third-party service indicating repair activity within a geographic location over which the one or more mobile sensors collect sensor data;
determine whether the repair data indicates that a repair was performed within proximity of the emitter between a time at which the first stream of information is received and a time at which the third stream of information is received; and
in response to determining that the repair was not performed within proximity of the emitter, determine that the leak indicated by the third stream of information is not distinct from the initial leak.

19. A method for detecting leaks near an emitter, comprising:
receiving, from one or more mobile sensors, a first stream of information indicative of a leak state;
determining that an initial leak state exists based at least in part on the first stream of information indicative of the leak state;
receiving a second stream of information indicative of a no-leak state;
using a statistical model to determine that the leak state has ended based at least in part on the first stream of information and the second stream of information;
receiving a third stream of information indicative of the leak state; and
determining that a new leak state exists, wherein the new leak state is a distinct leak state from the initial leak state.

20. A computer program product for detecting leaks near an emitter, the computer program product being embodied in a tangible computer readable storage medium and comprising computer instructions for:
receiving, from one or more mobile sensors, a first stream of information indicative of a leak state determining that an initial leak state exists based at least in part on the first stream of information indicative of the leak state;
receiving a second stream of information indicative of a no-leak state;
using a statistical model to determine that the leak state has ended based at least in part on the first stream of information and the second stream of information;
receiving a third stream of information indicative of the leak state; and
determining that a new leak state exists, wherein the new leak state is a distinct leak state from the initial leak state.

21. A method for classifying a gas signal, comprising:
receiving, from one or more mobile sensors, sensor data collected over a geographic region;
detecting a first gas signal in the sensor data;
determining a source type for the first gas based at least in part on a determination of whether the sensor data comprises a signal for another pollutant; and
providing the source type.

22. The method of claim 21, wherein the first gas signal corresponds to a methane gas signal.

23. The method of claim 22, wherein the other pollutant corresponds to ethane.

24. The method of claim 23, wherein the source type is deemed to correspond to a biogenic source type in response to a determination that the sensor data comprises the methane gas signal without a presence of an ethane gas signal.

25. The method of claim 23, wherein the source type is deemed to correspond to a thermogenic source type in response to a determination that the sensor data comprises the methane gas signal and an ethane gas signal.

26. The method of claim 23, wherein the sensor data is deemed to comprise an ethane signal in response to a determination that ethane measurements in the sensor data exceeds a noise baseline by a predefined extent.

27. The method of claim 26, wherein the predefined extent corresponds to at least 300% of the noise baseline.

28. The method of claim 27, wherein the noise baseline is a rolling baseline over a predefined time window.

29. A method for determining a ranking of sub regions within a geographic region based on the occurrence rate of gas leaks, comprising:
obtaining sensor data collected over a geographic region, wherein the sensor data is collected by one or more mobile sensors;
determining a model to predict a leak probability for one or more subregions within the geographic region based at least in part on the number of clusters, numbers of detections per cluster, and a collection intensity; and
providing the model.

30. The method of claim 29, wherein the gas corresponds to methane.

31. The method of claim 29, wherein the one or more subregions comprises one or more road segments.

32. The method of claim 29, wherein the detection probability includes a leak component corresponding to a probability of detecting a leak, and a no-leak component corresponding to a probability of detecting no leak.

33. The method of claim 32, wherein the detection probability includes a probability of detecting the leak if the leak is present.
